(19) United States
(12) Patent Application Publication
(10) Pub. No.: US 2022/0388915 A1
(43) Pub. Date: Dec. 8, 2022

(54) LOW PRESSURE CARBONATION CURING OF CONCRETE ELEMENTS AND PRODUCTS IN AN EXPANDABLE ENCLOSURE

(71) Applicant: THE ROYAL INSTITUTION FOR THE ADVANCEMENT OF LEARNING/MCGILL UNIVERSITY, Montréal (CA)

(72) Inventors: Yixin SHAO, Pincourt (CA); Xiangping XIAN, Montreal (CA); Mehrdad MAHOUTIAN, Montreal (CA)

(21) Appl. No.: 17/581,320

(22) Filed: Jan. 21, 2022

Related U.S. Application Data
(60) Provisional application No. 63/197,660, filed on Jun. 7, 2021.

(51) Int. Cl. C04B 40/02; C04B 38/10; B28B 11/24

(52) U.S. Cl. CPC C04B 40/0231; C04B 40/0259; C04B 40/0281; C04B 38/103; B28B 11/243; B28B 11/245

(57) ABSTRACT

A method for making a carbonated precast concrete product, includes: obtaining a mixture including at least one binder material, an aggregate, and water; molding the mixture into a molded intermediate; demolding the molded intermediate to obtain a demolded intermediate, the demolded intermediate having a first water-to-binder ratio; conditioning the demolded intermediate to provide a conditioned article having a second water-to-binder ratio less than the first water-to-binder ratio of the demolded intermediate; and curing the conditioned article using carbon dioxide at a pressure ranging from an atmospheric pressure to a pressure greater than the atmospheric pressure by at most 10% of the atmospheric pressure. Curing the conditioned article may be done within an expandable enclosure.

### CROSS-REFERENCE TO RELATED APPLICATIONS

This application claims priority from U.S. patent application 63/197,660 filed on Jun. 7, 2021, the entire contents of which is incorporated herein by reference.

### TECHNICAL FIELD

This disclosure relates generally to precast concrete products. More particularly, the present disclosure relates to carbonated precast concrete products and methods of making them.

### BACKGROUND

Precast concrete has become widely adopted in the construction industry. Precast concrete is a construction product that is cast in a reusable mold or form under controlled factory conditions. It cures in a controlled curing environment in the factory. After curing, it is then transported to the building site.

There is a wide range of structural and architectural applications for precast concrete. Some common examples include pavers, foundations, slabs, beams, floors, columns, walls, retaining walls, manholes, sewage pipes, blocks, modular boxes, bridge decks, and so on.

Curing precast concrete in a CO₂-rich environment may offer a reduction of the environmental impacts of precast concrete. This is known as carbonated precast concrete. While such carbonated precast concrete has certain environmental advantages, there remains a need to improve other physical properties of carbonated precast concrete, such as its ability to better endure freeze-thaw cycles and abrasion.

### SUMMARY

In one aspect, there is provided a method for making a carbonated precast concrete product, comprising: obtaining a mixture including at least one binder material, an aggregate, and water; molding the mixture into a molded intermediate; demolding the molded intermediate to obtain a demolded intermediate, the demolded intermediate having a first water-to-binder ratio; conditioning the demolded intermediate to provide a conditioned article having a second water-to-binder ratio less than the first water-to-binder ratio of the demolded intermediate; and curing the conditioned article at a pressure ranging from an atmospheric pressure to a pressure greater than the atmospheric pressure by at most 10% of the atmospheric pressure.

The method may include any of the following features and/or steps, in whole or in part, and in any combination.

In some embodiments, the curing of the conditioned article includes curing the conditioned article at the pressure greater than the atmospheric pressure by at most 5% of the atmospheric pressure.

In some embodiments, the curing of the conditioned article includes curing the conditioned article at the pressure greater than the atmospheric pressure by at most 0.2 psi.

In some embodiments, the molding of the mixture into the molded intermediate includes pre-curing the molded intermediate.

In some embodiments, the pre-curing of the molded intermediate includes pre-curing the molded intermediate for about five hours at a temperature of about 23 degrees Celsius and at a relative humidity of about 50% and exposed to an airflow having a speed of about 1 m/s.

In some embodiments, the conditioning of the demolded intermediate includes exposing the demolded intermediate to a wind having a speed of about 1 meter per second at a temperature of about 25 degrees Celsius and at a relative humidity of about 50%.

In some embodiments, the conditioning of the demolded intermediate includes conditioning the demolded intermediate until about 40% of a water content of the demolded intermediate has evaporated.

In some embodiments, the conditioning of the demolded intermediate includes conditioning the demolded intermediate until the conditioned article defines a porosity of about from 5 to 10% by volume.

In some embodiments, the conditioning of the demolded intermediate includes conditioning the demolded intermediate for a period of about from 5 to 6 hours.

In some embodiments, the curing of the conditioned article at the pressure greater than the atmospheric pressure by at most 10% of the atmospheric pressure includes disposing the conditioned article into an expandable enclosure defining an inner chamber sealed from an environment outside thereof.

In some embodiments, carbon dioxide is injected into the expandable enclosure.

In some embodiments, the expandable enclosure is vacuumed before the injecting of the carbon dioxide.

In some embodiments, the curing of the conditioned article is performed at a temperature of about 25 degrees Celsius.

In some embodiments, the curing of the conditioned article includes curing the conditioned article for 12 hours.

In some embodiments, the concrete product is hydrated after the curing at a temperature of about 25 degrees Celsius and at a relative humidity of about 99%.

In some embodiments, the hydrating includes hydrating the concrete product for 27 days.

In another aspect, there is provided a method for making a carbonated precast concrete product, comprising: obtaining a conditioned article, the conditioned article being a molded intermediate concrete product; sealing the conditioned article within an inner chamber of an expandable enclosure, the expandable enclosure having an operational configuration and a non-operational configuration, a volume of the inner chamber greater in the operational configuration than in the non-operation configuration; injecting carbon dioxide inside the inner chamber until a pressure inside the inner chamber ranges from an atmospheric pressure to a pressure greater than the atmospheric pressure by at most 10% of the atmospheric pressure; and curing the conditioned article with the carbon dioxide injected inside the inner chamber of the expandable enclosure to produce the carbonated precast concrete product.

The method may include any of the following features and/or steps, in whole or in part, and in any combination.

In some embodiments, the method includes deploying the expandable enclosure from the non-operational configuration to the operational configuration.

In some embodiments, the deploying of the expandable enclosure includes inflating the expandable enclosure with the injecting of the carbon dioxide inside the inner chamber.

In some embodiments, the curing of the conditioned article includes curing the conditioned article at the pressure greater than the atmospheric pressure by at most 5% of the atmospheric pressure.

In some embodiments, the curing of the conditioned article includes curing the conditioned article at the pressure greater than the atmospheric pressure by at most 0.2 psi.

In some embodiments, the method includes vacuuming the expandable enclosure before the injecting of the carbon dioxide while the conditioned article is inside the inner chamber.

In some embodiments, the curing of the conditioned article is performed at a temperature of about 25 degrees Celsius, for 12 hours, the method comprising hydrating the concrete product after the curing at a temperature of about 25 degrees Celsius and at a relative humidity of about 99%.

Many further features and combinations thereof concerning the present improvements will appear to those skilled in the art following a reading of the instant disclosure.

### BRIEF DESCRIPTION OF THE DRAWINGS

FIG. 1A is a schematic view of a system for curing concrete products;

FIG. 1B is a schematic three dimensional view of an expandable enclosure of the system of FIG. 1A, the expandable enclosure shown in a collapsed configuration;

FIG. 10 is a schematic three dimensional view of the expandable enclosure of FIG. 1B shown in a deployed configuration; and

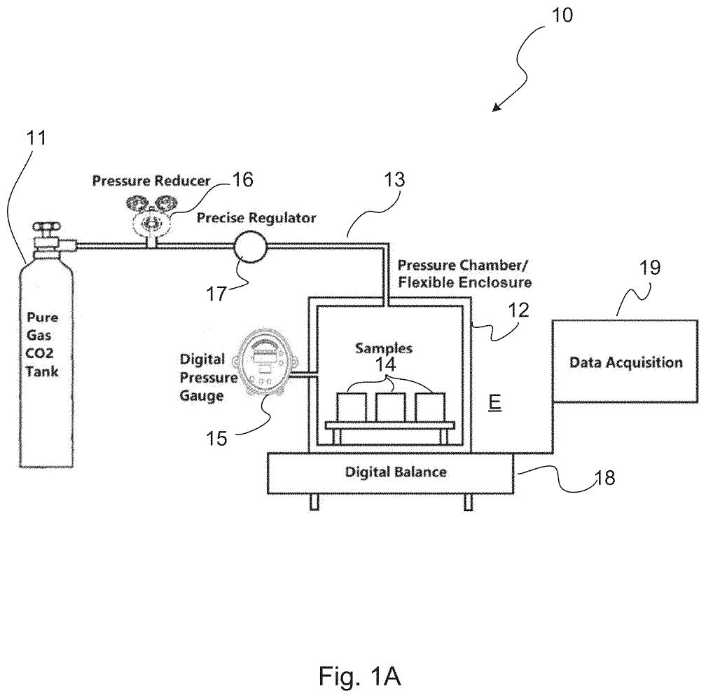

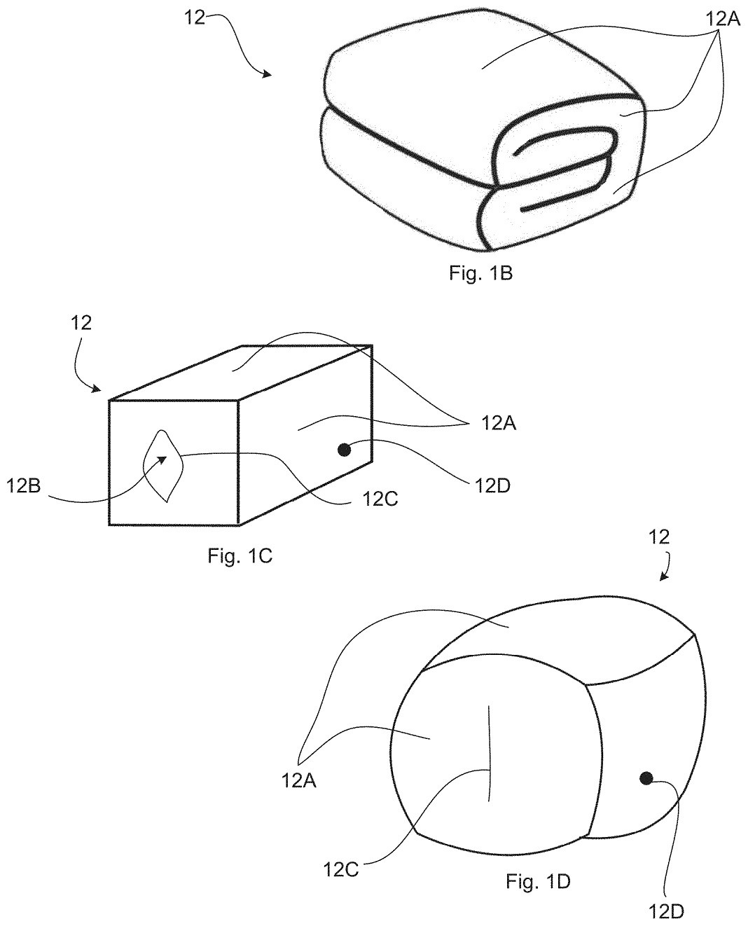

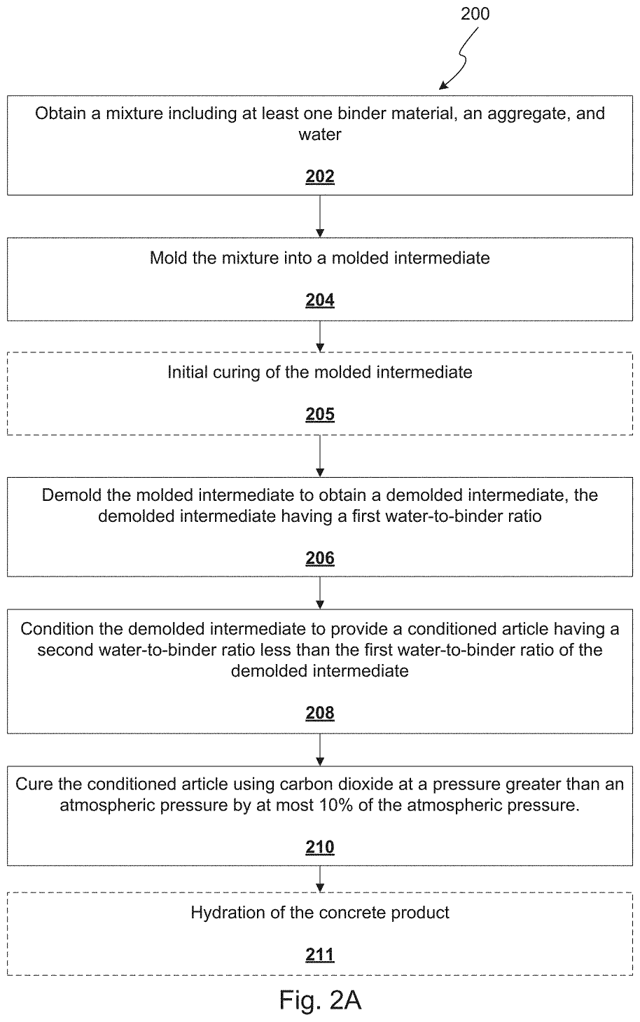

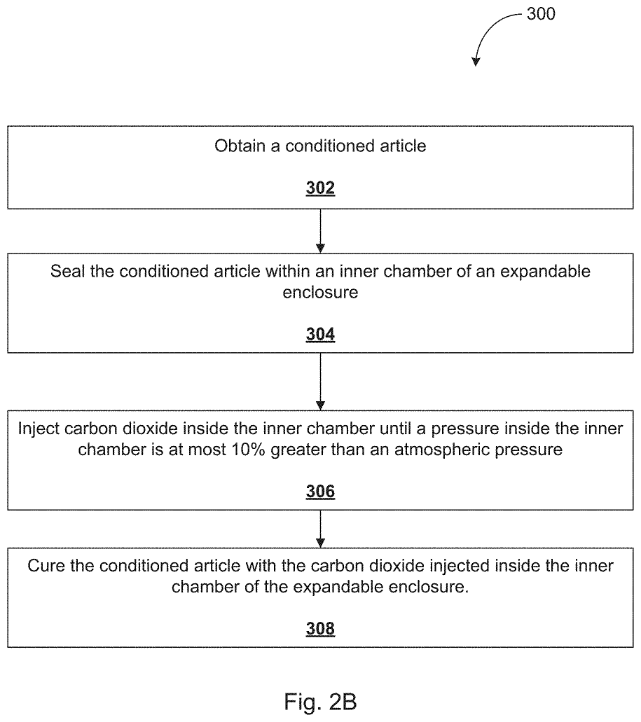

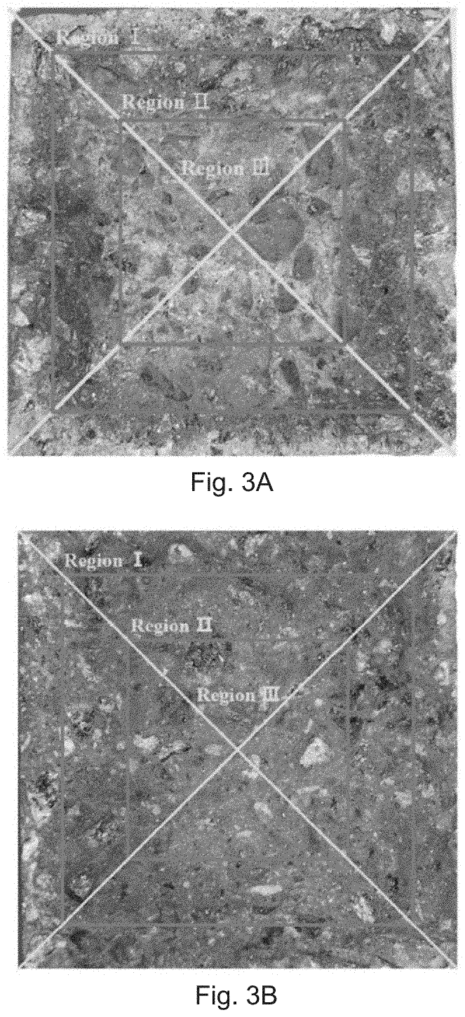

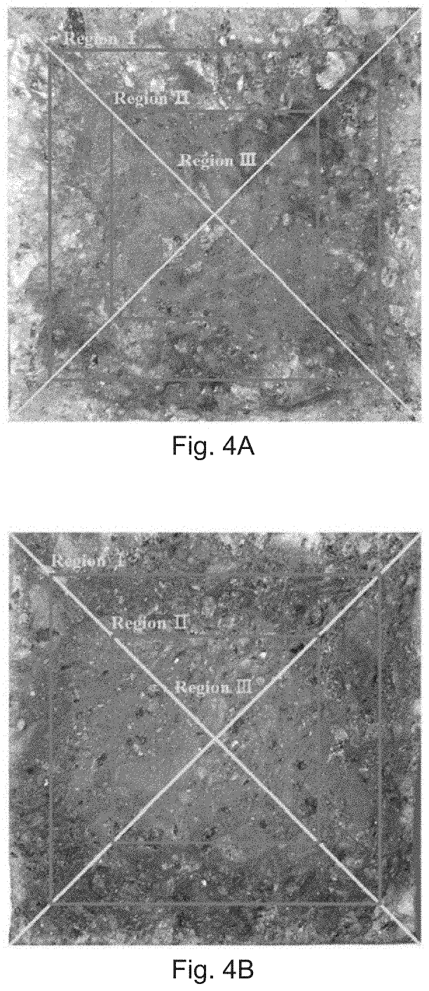

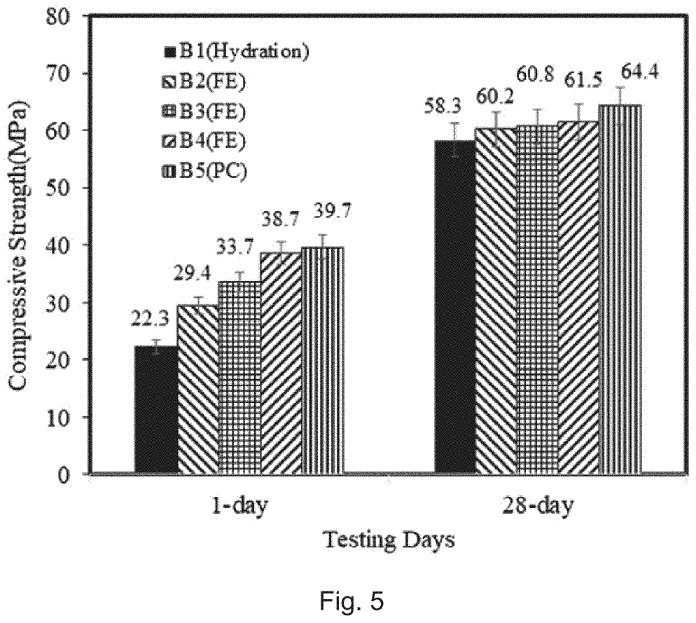

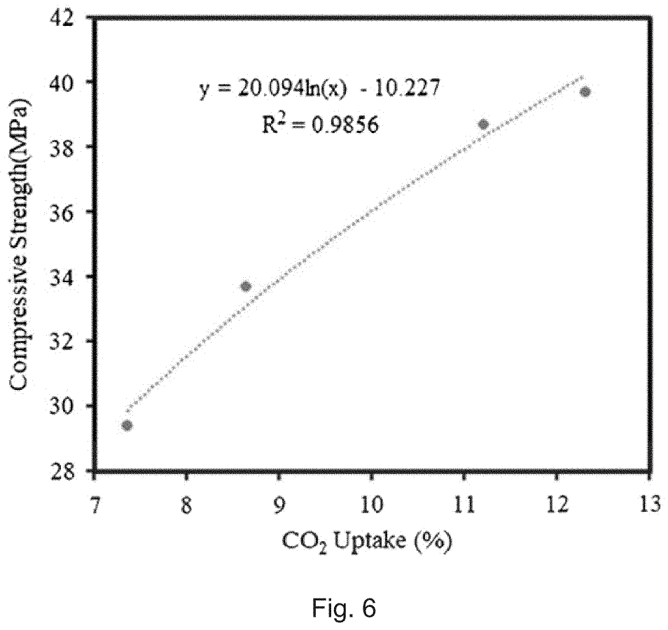

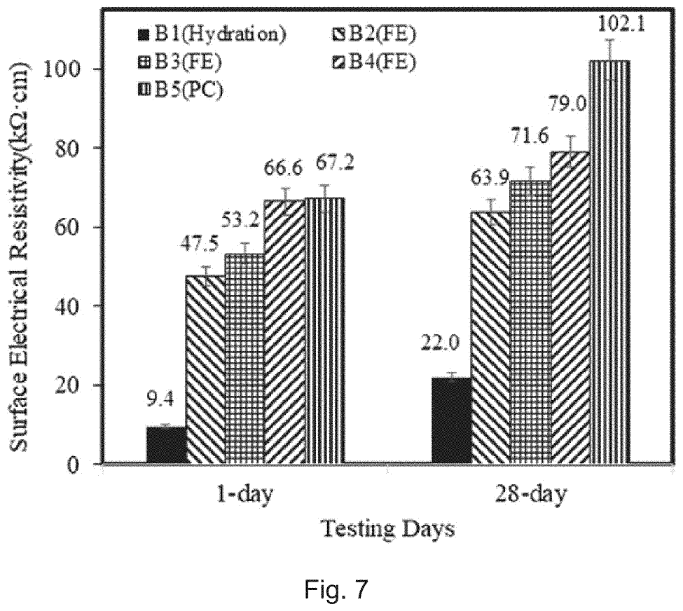

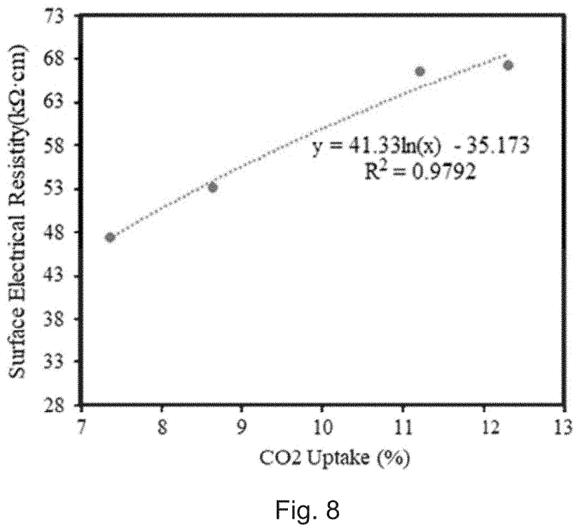

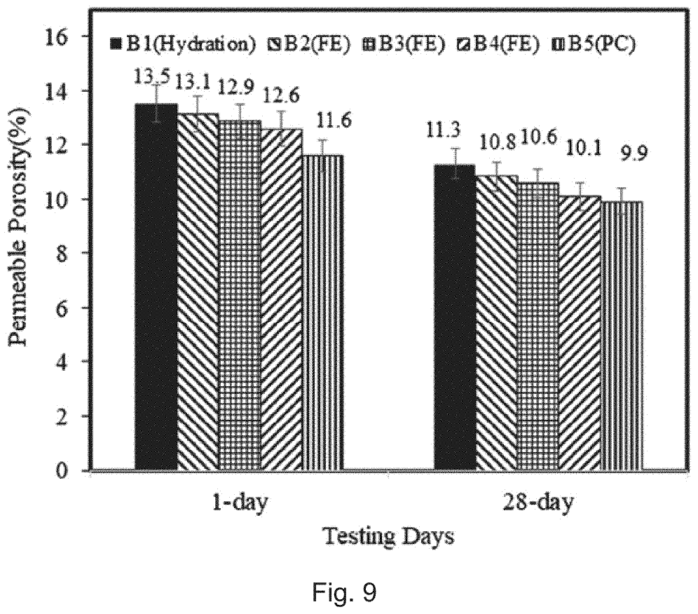

FIG. 1D is a schematic three dimensional view of the expandable enclosure of FIG. 1B shown in an inflated configuration;

FIG. 2A is a flow chart illustrating steps of a process of manufacturing concrete products;

FIG. 2B is a flow chart illustrating steps of another process of manufacturing concrete products;

FIG. 3A is a cross-sectional area of a concrete product manufactured using the process of FIG. 2A taken after 12 hours of carbonation using a set of parameters B4;

FIG. 3B is a cross-sectional area of a concrete product manufactured using the process of FIG. 2A taken after 27 days of carbonation and subsequent hydration using the set of parameters B4;

FIG. 4A is a cross-sectional area of a concrete product manufactured using the process of FIG. 2A taken after 12 hours of carbonation using a set of parameters B5;

FIG. 4B is a cross-sectional area of a concrete product manufactured using the process of FIG. 2A taken after 27 days of carbonation and subsequent hydration using the set of parameters B5;

FIG. 5 is a graph illustrating compressive strength taken at different time intervals of different concrete products manufactured using the process of FIG. 2A with different sets of parameters;

FIG. 6 is a graph illustrating a variation in the compressive strength as a function of carbon dioxide uptake after 1-day;

FIG. 7 is a graph illustrating surface electric resistivity taken at different time intervals of different concrete products manufactured using the process of FIG. 2A with different sets of parameters;

FIG. 8 is a graph illustrating a variation in the surface electric resistivity as a function of carbon dioxide uptake after 1-day;

FIG. 9 is a graph illustrating a permeable porosity taken at different time intervals of different concrete products manufactured using the process of FIG. 2A with different sets of parameters;

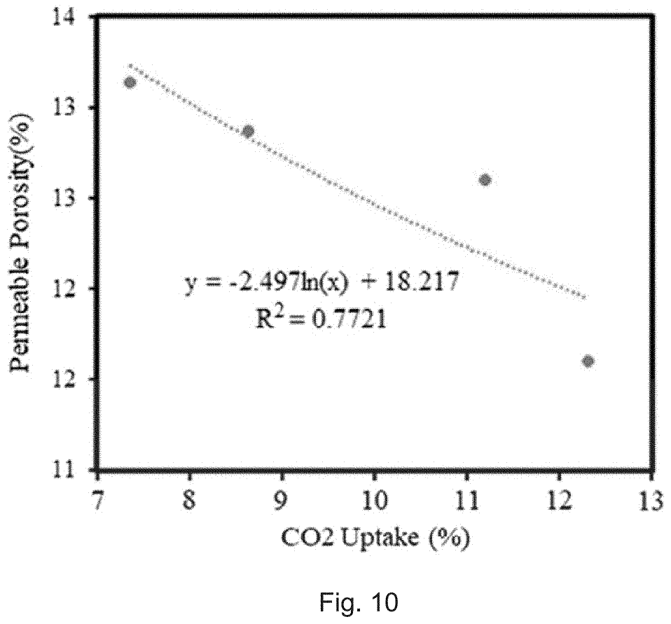

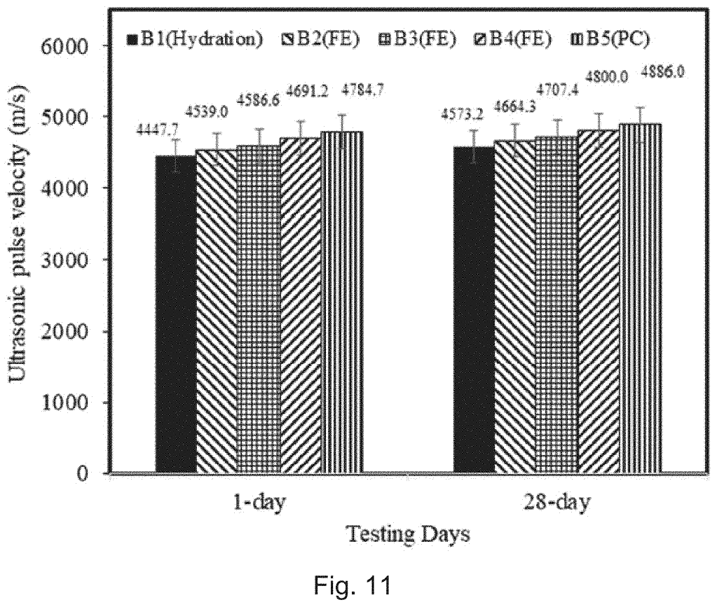

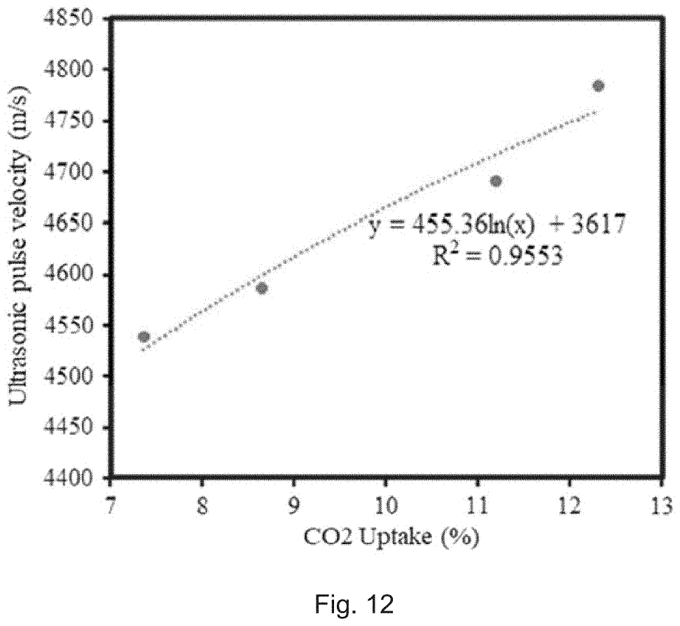

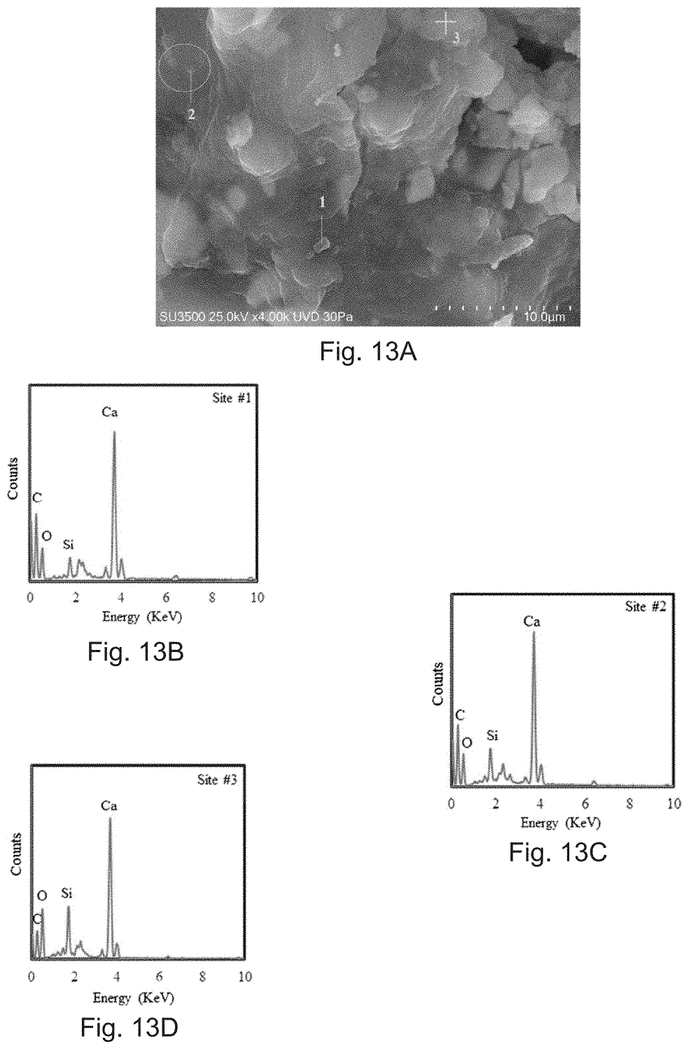

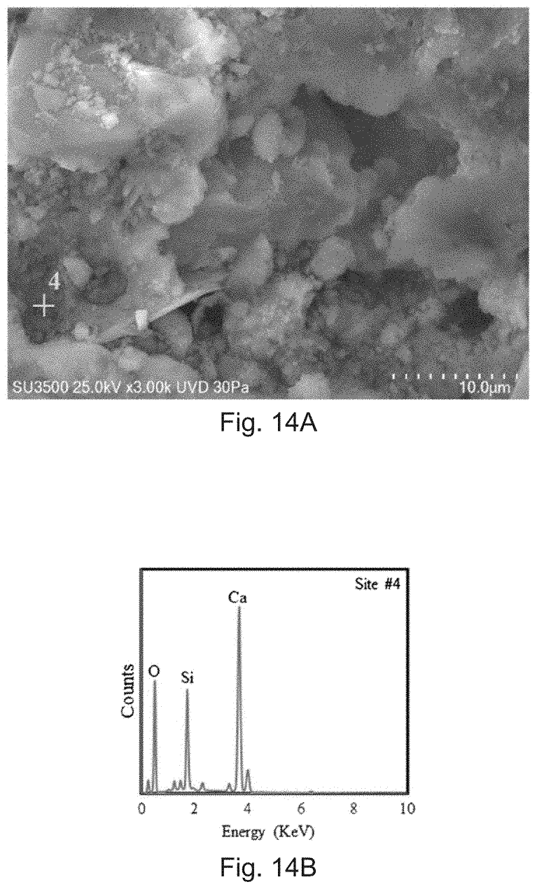

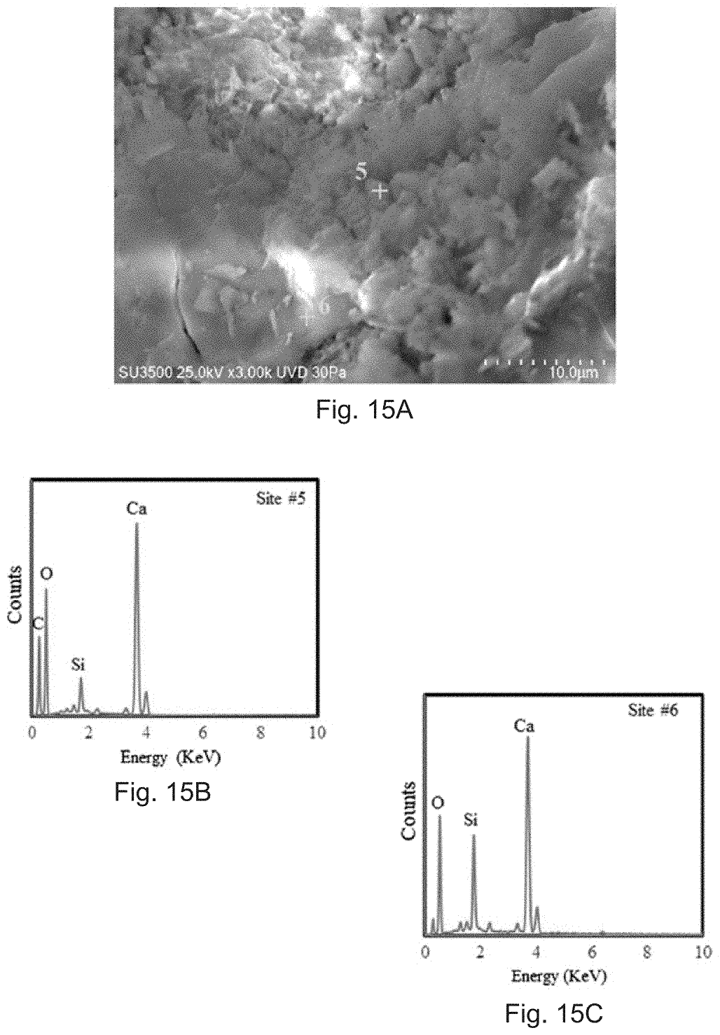

FIG. 10 is a graph illustrating a variation in the permeable porosity as a function of carbon dioxide uptake after 1-day;

FIG. 11 is a graph illustrating an ultrasonic pulse velocity taken at different time intervals of different concrete products manufactured using the process of FIG. 2A with different sets of parameters;

FIG. 12 is a graph illustrating a variation in the ultrasonic pulse velocity as a function of carbon dioxide uptake after 1-day;

FIG. 13A illustrates an energy-dispersive X-ray spectroscopy (EDS) image of a microstructure of concrete carbonated using the process of FIG. 2A using a set of parameters B4;

FIG. 13B is a graph showing an EDS analysis of Site #1 in FIG. 13A;

FIG. 13C is a graph showing an EDS analysis of Site #2 in FIG. 13A;

FIG. 13D is a graph showing an EDS analysis of Site #3 in FIG. 13A;

FIG. 14A illustrates an energy-dispersive X-ray spectroscopy (EDS) image of a microstructure of concrete carbonated using the process of FIG. 2A using another given set of parameters B1;

FIG. 14B is a graph showing an EDS analysis of Site #4 in FIG. 14A;

FIG. 15A illustrates an energy-dispersive X-ray spectroscopy (EDS) image of a microstructure of concrete carbonated using the process of FIG. 2A using a given set of parameters B5;

FIG. 15B is a graph showing an EDS analysis of Site #5 in FIG. 15A; and

FIG. 15C is a graph showing an EDS analysis of Site #6 in FIG. 15A.

### DETAILED DESCRIPTION

The present process for preparing carbonated precast concrete products may require less, and, in some cases, no cement, and may allow concrete to store CO2 within the product. Carbonation curing also offers the potential to introduce industrial waste materials as cement replacements. These waste material include, for instance, steel slag and stainless steel slag. The processes of the present disclosure may not only be able to reduce the CO2 footprint of concrete, but may also allow precast concrete products to be made in a more affordable manner due to the use of currently under-utilized, low-cost industrial waste materials such as steel slag and bottom ash. Steel slag is a by-product of steel making, and is produced during the separation of molten steel from impurities in steel-making furnaces. The steel slag occurs as a molten liquid melt and is a solution including silicates and oxides that solidifies upon cooling. Bottom ash is a coarse, granular, incombustible by-product of coal combustion that is collected from the bottom of furnaces.

Examples of precast concrete products which may be produced using the methods described herein include, but are not limited to, concrete pipes, traffic barriers, walls including retaining walls, boxes including modular boxes, culverts, tiles, pavers, foundations, slabs including hollow-core slabs, patio slabs, steps, curbs, concrete masonry units, beams, floors, columns, manholes, sewage pipes, railroad ties, and other precast concrete products.

The manufacturing of carbonated precast concrete products differs from the manufacture of traditional cement-based precast concrete mainly in the application of carbon dioxide during the carbonation curing process and a broader selection of qualified binder sources (e.g., cement). Carbonated precast concrete acquires its strength mainly through the reaction between the introduced carbon dioxide gas with the oxides, and/or hydroxides of calcium and/or magnesium in the binder, with the help of sufficient amount of water in the mixture. When exposed to high or low concentrations of CO2, precast containing such minerals often experience rapid hardening.

### Curing System

Referring now to FIG. 1A, a system for curing a concrete product at a low pressure is shown at 10. As will be explained below, in the context of the present disclosure “low pressure curing” implies curing at pressures within the same magnitude of atmospheric pressure. For instance, curing at a pressure slightly greater than the atmospheric pressure is considered low pressure curing. Low pressure in this context is therefore intended to mean a curing pressure that is less than 6 psi, optionally less than 5 psi, or more optionally still, less than 1 psi. The system 10 includes a source of carbon dioxide, shown as a pressurized tank 11 containing carbon dioxide. An enclosure 12 is pneumatically connected to the source of carbon dioxide 11 via suitable conduit 13. The enclosure 12 defines an inner chamber sized for accepting the concrete products 14 to be cured. A pressure sensor 15, such as a pressure gauge, is operatively connected to the enclosure 12 and may be used to monitor a pressure inside the enclosure 12. Since a pressure of the carbon dioxide inside the tank 11 may be greater than the pressure at which the concrete products 14 are being cured, a pressure reducer 16 may be pneumatically connected to the conduit 13 downstream of the source of carbon dioxide 11 and upstream of the enclosure 12. The pressure reducer 16 is operable to limit a pressure of the carbon dioxide that flows into the enclosure 12. A pressure regulator 17 may be used to fine tune the pressure of the carbon dioxide that reaches the enclosure 12.

The enclosure 12 may be an expandable enclosure that is inflatable with the carbon dioxide from the pressurized vessel. The expandable enclosure as described herein may also be flexible, and thus may also be described as a flexible enclosure. The expandable enclosure as defined herein is understood to mean an enclosure that may be deployed from a configuration suitable for transportation to an in-use configuration suitable for receiving the concrete product to be cured with carbon dioxide. The enclosure may be qualified as expandable if its inner volume is greater in the in-use configuration than in the transport configuration. The expandable enclosure may be inflatable, either with walls that are flexible or with rigid walls interconnected to one another (e.g., accordion). The expression “flexible” means that the walls may change in shape as a result of a pressure increase in the inner volume of the enclosure. In some embodiments, the enclosure may be expandable if it includes a plurality of flexible or rigid walls that may be assembled to create an inner volume sized to receive products to be cured with carbon dioxide.

The enclosure 12 includes an opening sized for receiving the concrete product to be cured. The opening is sealable, for instance, with a zipper. When not in use, the enclosure 12 may therefore be folded and carried on the job site for manufacturing the concrete product directly on the job site. Hence, the enclosure and the process that will be described herein below may avoid having to transport heavy concrete product from a manufacture to a job site. The concrete products may be manufactured on site as needed. In some embodiment, the expandable enclosure may include a plurality of walls interconnectable to one another in a sealed manner. These walls, which may be stiff or flexible, may be transported on site and the enclosure may be built as needed by construction workers for the manufacturing of the concrete products. The enclosure 12 may include a structure of interconnected walls with a membrane affixed to those walls; the membrane providing an impermeability to gases to the enclosure 12. Alternately, the membrane itself may form the wall or walls of the enclosure 12. Curing the concrete directly on site with the enclosure 12 may reduce CO2 emission since the heavy concrete products no longer need to be transported via public roads and using polluting heavy vehicles.

Referring now concurrently to FIGS. 1B to 1D, the expandable enclosure 12 may include one or more flexible wall portions 12A, which may be made of an airtight fabric or membrane that is non-permeable to gases. The expandable enclosure 12 may have a substantially rectangular shape, but any other suitable shapes are contemplated. Hence, the expandable enclosure 12 may be a bag or other non-rigid container that can be folded and/or collapsed for transportation to job sites and deployed, in situ, at a job site. The expandable enclosure 12 is used in a non-operational configuration (e.g. collapsed, stored, folded, etc.) as shown in FIG. 1B. As shown in FIG. 1C, the expandable enclosure 12 is shown in a deployed or operational configuration. Once deployed, the expandable enclosure 12 defines an inner chamber 12B circumscribed by the flexible wall portions 12A. An opening 12C, which can be sealed closed when required, is used to insert the concrete product into the inner chamber 12B formed within the expandable enclosure 12 for curing of the concrete product. The expandable enclosure 12 has one or more ports 12D for the injection of carbon dioxide. In some cases, the expandable enclosure 12 has one or more ports for extracting air from the inner chamber. In some embodiments, the wall portions 12A are made of the non-gas permeable fabric or membrane are substantially non-extensible, while still being non-rigid and thus bendable in order for the expandable enclosure 12 to be collapsed (FIG. 1B) for transportation and subsequently deployed and expanded for curing. Hence, a pressure for the carbonation curing may be limited by a strength of the expandable wall portions and/or by seams via which the different expandable wall portions are joined together. As shown in FIG. 1D, once the carbon dioxide is injected inside the inner chamber 12B of the expandable enclosure 12, the expandable enclosure 12 is in an inflated configuration and may appear like an inflated balloon with the flexible wall portions 12A being arced outward or convex when seen from the outside of the inner chamber 12B. In some other embodiments, the flexible wall portions 12A may be made of a fabric that is extensible in one or more directions. In such an embodiment, therefore, the flexible wall portions of the expandable enclosure can be stretched, whereby the internal volume defined within the walls of the enclosure can be varied—e.g. increased—as desired such as to include a desirable volume of gas therein and/or to receive differently sized and/or shaped concrete products. The expandable enclosure 12 may, for example, be provided in the form of a stretchable “balloon” with one or more stretchable membranes that can expand to increase the volume of the inner cavity defined there within. In one particular embodiment, the material of main body of this expandable enclosure is PVC (polyvinyl chloride) plastic. However, any suitable deformable material that can hold limited pressure may be used as main body. The pressure-resistant, air-tight zipper enables the ability of flexible transformation of enclosure. Any suitable air tight closing means are contemplated.

### Process

Referring to FIG. 2A, there is provided a process 200 for making a carbonated precast concrete product according to the present disclosure. As will be described in more detail below, the process 200 includes obtaining a mixture of raw materials at 202. The raw materials include the binder(s), aggregate, water, and some optional additives. The process 200 includes molding the mixture of the at least one binder, aggregate, and water into a molded intermediate at 204. In some embodiments, the molding of the mixture into the molded intermediate at 204 includes forming the mixture to obtain a formed intermediate and consolidating the formed intermediate to obtain a consolidated intermediate, which may correspond to the molded intermediate. An optional step of performing an initial curing of the molded intermediate may be carried at 205. The process 200 includes demolding the molded intermediate to obtain a demolded intermediate at 206 after the initial curing 205 if said initial curing is performed. The demolded intermediate has a first water-to-binder ratio. The process 200 includes conditioning the demolded intermediate to provide a conditioned article having a second water-to-binder ratio less than the first water-to-binder ratio at 208. The second water-to-binder ratio of the conditioned article is less than the first water-to-binder ratio of the demolded intermediate. The process 200 includes curing the moisturized product with carbon dioxide at a pressure ranging from an atmospheric pressure to a pressure greater than the atmospheric pressure by at most 10% of the atmospheric pressure at 210. In other words, a pressure differential between a pressure inside the expandable enclosure and a pressure of an environment outside the expandable enclosure may range from 0 to 10% of the pressure of the environment. In yet other words, the low pressure carbonation curing may be performed at a pressure greater than an atmospheric pressure of the environment E by at most 10% of the atmospheric pressure, optionally at most 5%, more optionally still at most 0.2 psi above the atmospheric pressure. High-pressure curing may include pressures being at least 1 bar, typically between 1 and 10 bars. Any curing pressure less than 1 bar may be referred to as low-pressure curing as defined and understood herein. In some embodiments, the low-pressure curing is carried at a pressure at or less than 0.1 bar (1.4 psi). Optionally, the concrete product may be hydrated at 211. In some embodiments, the concrete samples may be kept in a mold for at least 5 hours after casting until they reach initial set and thereafter demolded for conditioning for another 6 hours. The conditioning may be designed to remove 40% of free water of each sample based on its mix design to make rooms for calcium carbonate deposition during carbonation curing.

### Mixing of Components

The mixing at 202 is performed with at least one binder material, aggregate, water and optionally additives such as admixtures. In one embodiment, prior to the mixing at 202, the process may include step of a) of providing a dry part and a liquid part, said dry part is comprising at least one aggregate material and at least one binder material, and said liquid part is comprising water and optionally additives and combining the dry and liquid parts.

Additives and other ingredients can be optionally introduced into the mix in some embodiments and if needed as a function of the intended use of the concrete product.

### Forming and Consolidating

The molding of the mixture at 204 may include forming by adding a sufficient amount of mixed material containing binder, suitable aggregate, water and optionally additives by any known means into a mold for forming the components into a desired shape. Although “mold” or “molding” is used herein, the expression is contemplating any hollow form or matrix for providing a shape such as a frame/mold and then optionally levelled. In other words, the mixture may be molded in such a way as to define an inner chamber.

The consolidating, which is included in the molding at 204, is comprising a consolidation of the formed intermediate to the desired thickness, shape and density, for example using vibrating or compacting or compressing or combined forces. The desired thickness, shape, and density can be selected depending on the desired application as known in the art.

The steps of forming and consolidating together may be referred to herein as molding the product. In other words, the step of forming and the step of consolidating may be regarded as two sub-steps of the step 204 of molding the mixture.

In one embodiment, prior to the forming, the process 200 is comprising a further step of mixing at least one binder material, aggregate, water and optionally additives to provide a substrate mixture, wherein said mixing can be conducted before, at the same time or after the step of mixing. In some cases, the mixing of the substrate mixture and the forming of the substrate may be repeated. In further embodiments, each of said mixtures of at least one binder material, aggregate, water and optionally additives may be comprising the same or different ratios of those components. However, at least one of those mixtures is comprising a binder other than cement, such as a slag binder, or steel slag for example. This ambient pressure curing system in the expandable enclosure may also be used to cure steel-slag based concrete products.

### Initial Curing (Optional)

In some cases, especially when precast concrete is fabricated with a wet cast process, a step of initially curing, or pre-curing, the molded intermediate is optionally performed at 205 to offer the molded intermediate a satisfactory initial strength before it is taken out of the mold at 206. Precast concrete relies on the hydration/setting of binder or other physical/chemical/activation to achieve the desired strength gain in this initial curing stage which, for example, lasts from 2 hours up to a few days. In one embodiment, the pre-curing of the molded intermediate is performed for 5 hours at a temperature of about 23 degrees Celsius and at a relative humidity of about 50%. In some embodiments, the pre-curing may be carried at a temperature of from 15 to 30 degree Celsius, at a relative humidity of from 30% to 60%, and from 5 to 12 hours. This may vary as a function of the water-to-cement/steel-slag ratio of sample.

### Conditioning (Reducing the Quantity of Water in De-Molded Precast Concrete)

Although carbonation curing can occur immediately after precast concrete is de-molded, it is common to condition the consolidated concrete for a certain period of time before carbon dioxide gas is introduced. The conditioning at 208 begins after the demolding of the molded intermediate at 208 and before the curing of the demolded intermediate with CO₂ at 210. The conditioning at 208 involves the controlled removal of excess water. Its main purpose is to facilitate a quick and uniform carbonation reaction within concrete by removing excessive water. A surplus of water can limit the reaction by blocking the diffusion of CO₂ to the reactants, while insufficient water content can cause water starvation, halting the reaction. Thus, an optimal water content may be achieved prior to carbonation for an optimal carbonation.

The conditioning of 208 is conducted on the demolded intermediate (optionally after an initial curing) product after the demolding at 206. The conditioning may be carried at room temperature, temperature of 15-25° C. and humidity of 30-60%, and with or without the assistance of forced air circulation. The duration of conditioning may vary from 10 minutes up to 24 hours or longer. This conditioning may help to reduce the moisture content of precast concrete through water evaporation. The released moisture leaves numerous pores inside the consolidated precast concrete, which may be critical for achieving a uniform carbonation throughout the whole precast concrete product with a desired CO₂ uptake. A relatively great CO₂ uptake and a uniform carbonation distribution may be very important to the physical-mechanical properties of carbonated precast concrete product. In one embodiment, 20-70%, preferably 30-60% and especially 40-50% by weight, of the initial moisture in the mixture is taken out of precast concrete at the end of the step 112 of conditioning. Other known ways of reducing the moisture, e.g. heat, can be alternatively used during the conditioning step.

In one embodiment, the conditioning of the demolded intermediate at 208 includes exposing the demolded intermediate to a wind having a speed of about 1 meter per second at a temperature of about 25 degrees Celsius and at a relative humidity of about 50%. The temperature for the conditioning may range from 15 to 30 degree Celsius, and the relative humidity may range from 30% to 60%. In one embodiment, the conditioning of the demolded intermediate includes conditioning the demolded intermediate until about 40% of a water content of the demolded intermediate has evaporated. In one embodiment, the conditioning of the demolded intermediate includes conditioning the demolded intermediate until the conditioned article defines a porosity of about from 5 to 10% by volume. The conditioning of the demolded intermediate may include conditioning the demolded intermediate for a period of about from 5 to 6 hours. The conditioning is designed to remove 40% of free water by weight of free water of each specimen based on its mix design.

### CO₂ Curing and Optional Air Drying

The curing at 210 may be done immediately after the conditioning at 208. In the embodiment shown, the curing 210 is performed by placing the conditioned article into the enclosure 12 (FIG. 1).

Referring now to FIG. 2B, another process is shown at 300. The process 300 includes obtaining a conditioned article at 302, the conditioned article being a molded intermediate concrete product; sealing the conditioned article within the inner chamber 12B of the expandable enclosure 12 at 304, the expandable enclosure 12 having an operational configuration and a non-operational configuration, a volume of the inner chamber 12B greater in the operational configuration than in the non-operation configuration; injecting carbon dioxide inside the inner chamber 12B until a pressure inside the inner chamber ranges from the atmospheric pressure to a pressure greater than the atmospheric pressure by at most 10% of the atmospheric pressure at 306; and curing the conditioned article in the inner chamber 12B of the expandable enclosure 12 at 308.

In the present embodiment, the method 300 includes deploying the expandable enclosure 12 from the non-operational configuration to the operational configuration. The deploying of the expandable enclosure 12 may include inflating the expandable enclosure 12. The inflating may be done simultaneously with the injecting of the carbon dioxide in the inner chamber 12B. Stated differently, the injecting of the carbon dioxide may result in the inflation and deployment of the expandable enclosure 12.

The curing of the conditioned article may include curing the conditioned article at the pressure greater than the atmospheric pressure by at most 5% of the atmospheric pressure. The curing of the conditioned article may include curing the conditioned article at the pressure greater than the atmospheric pressure by at most 0.2 psi.

In some embodiments, the expandable enclosure is vacuumed before the injecting of the carbon dioxide while the conditioned article is inside the inner chamber. The curing of the conditioned article may be performed at a temperature of about 25 degrees Celsius and may be performed for 12 hours. In some embodiments, the concrete product is hydrated after the curing. The hydration may be performed at a temperature of about 25 degrees Celsius and at a relative humidity of about 99%.

### Binders

The cementitious and/or non-cementitious binder in carbonated precast concrete includes any of the following carbonatable materials as well as their combinations: ordinary Portland cement, other types of cement, non-hydraulic cement, hydraulic cement, ground granulated blast-furnace slag (GGBFS), steel slag, fly ash, bottom ash, stainless steel slags, and other materials that are rich in CaO and/or MgO and/or calcium-silicate content. Any suitable combinations of two or more binders may be used. In some cases, a single binder may be used. In some embodiments, the binder is a cementitious binder and may comprise ordinary Portland cement, other types of cement, non-hydraulic cement, hydraulic cement, and combinations thereof. In some embodiments, the binder is a non-cementitious binder and may comprise steel slag, fly ash, bottom ash, stainless steel slags, and other materials that are rich in CaO and/or MgO, calcium-silicate content, and combinations thereof. In one particular example, the binder is a non-cementitious binder and comprises less than 5%, less than 4%, less than 3%, less than 2%, or less than 1% by weight of cement.

For example, steel slag can be used herein as the sole component of a binder or the main component of a binder together with a proportion of cement, if needed, to allow for the production of carbonated precast concrete products wherein carbon dioxide is used as the curing agent. In other words, all or a majority of the cement is replaced by steel slag. Carbon dioxide is also applied to promote strength, cure, and activate the slag.

In one embodiment, the binder consists of steel slag. In some cases, the binder includes steel slag and another suitable component.

In one embodiment, the binder is essentially comprised of steel slag. The term “essentially comprised of” as used herein can mean, in one example, at least 90%, at least 91%, at least 92%, at least 93%, at least 94%, at least 95%, at least 96%, at least 97%, or at least 98% by weight. In some cases, the binder may include a majority (e.g., more than 50% by weight) of steel slag.

In one embodiment, the binder comprises steel slag and cement in a weight ratio of steel slag to cement of about 1:20, about 1:15, about 1:10, 1:5, from about 1:20 to about 20:1, from about 1:10 to about 10:1, or from about 1:5 to about 5:1. Alternatively, in some embodiments, the weight ratio of steel slag to cement is about 20:1, or about 15:1 or about 10:1 or about 5:1.

In a further embodiment, especially in a multilayered product as defined herein, the binder in the top/external layer is consisting of steel slag or is comprising essentially of steel slag, or is comprising a steel slag to cement in a weight ratio of about 1:20 to about 20:1 or the weight ratio of steel slag to cement is about 20:1, or about 15:1 or about 10:1 or about 5:1.

In one embodiment, the weight ratio of the binder (such as any or all of steel slag, cement and other carbonatable materials) to the total weight of the composition comprising the aggregate+binder+water+additives, ranges from about 0.20 to about 0.60, preferably from about 0.25 to about 0.50 or more preferably from about 0.30 to about 0.50.

### Cement

In this disclosure, the following non-limiting list of cements can be used to produce carbonated precast concrete: Portland cement (Type I-Type V); Portland-limestone cement;

rapid hardening cement; quick setting cement; low heat cement; blast-furnace slag cement; Portland-slag cement; high alumina cement; white cement; colored cement; Pozzolanic cement (Portland-Pozzolan Cement); air entraining cement; hydrographic cement; non-hydraulic cement, and ternary blended cement.

As used herein, the cements that are useful are those that contain calcium silicate phases, specifically C3S, that enable them to gain strength when reacted with water. The presence of calcium silicate phases secures the short term and long term strength development.

### Steel Slag and Stainless Steel Slag

“Steel slag” herein refers to the slag by-product produced from making steel. Steel slag may include slag produced from Basic Oxygen Furnaces (BOF), also known as slag from the Linz-Donawitz (LD) process, LD slag. Steel slag may also include slag produced from Electric Arc Furnaces (EAF). Steel slag as used herein may further include ladle slag. Steel slag can be a combination of above slags. It will be understood that “steel slag” as used herein excludes iron slag and blast furnace slag that are typically generated during iron production and that may be used in making cement, such as pozzolanic slag.

“Ladle slag” as used herein refers to a type of steel slag. Ladle slag is produced as a by-product from a ladle refining operation. In various steel making processes, molten steel produced in an EAF or BOF process undergoes an additional refining process based on the quality of the desired steel.

“EBH slag” as used herein refers to EAF-BOF Hybrid, which is a type of steel slag formed of a mixture of EAF and BOF produced slags.

Stainless steel slag may include slag generated from the stainless steel production. Stainless steel slag is mainly generated from the argon oxygen decarburization (AOD) and/or ladle metallurgy (LM) process.

### Chemical Composition of Steel Slag:

In one embodiment, the steel slag used herein has a cumulative calcium silicate content (ex: CS+C2S+C3S phase concentration) of at least about 15% by weight.

In one embodiment, the steel slag used herein has a cumulative calcium silicate content (ex: CS+C2S+C3S phase concentration) of at least about 20% by weight.

In one embodiment, the steel slag used herein has a cumulative calcium silicate content (ex: CS+C2S+C3S phase concentration) of at least about 30% by weight.

In one embodiment, the steel slag used herein has a cumulative calcium silicate content (ex: CS+C2S+C3S phase concentration) of at least about 40% by weight.

In one embodiment, the steel slag used herein has a SiO2 content of at least about 6% or more preferably at least about 15% by weight.

In certain other embodiments, the binder may be a mixture of Ordinary Portland Cement, and any suitable slags (steel slag, stainless steel slag, etc). Any suitable binders, in any suitable combinations, may be used for low-pressure curing.

### Chemical Composition of Stainless Steel Slag:

In one embodiment, the stainless steel slag used herein has a SiO2 content of at least about 15% or more preferably at least about 20% by weight.

In one embodiment, the stainless steel slag used herein has a calcium oxide content of at least about 30% or more preferably at least about 35% by weight.

### Physical Characteristics of Steel Slag:

The steel slag may include a mixture of coarse slag pieces and fine slag pieces. Coarse slag pieces may have a Blaine fineness less than about 50 m2/kg and fine slag pieces may have a Blaine fineness greater than about 50 m2/kg. The coarse slag pieces, the fine slag pieces, or both may be land-filled as an outcome from typical steel making process. Received steel slag originating from waste (such as land-fill and/or industrial waste) may optionally be refined.

Refining the steel slag may include filtering the received steel slag to separate fine slag pieces from coarse slag pieces.

Alternatively, or additionally, refining the received steel slag may also include pulverizing the steel slag to a fine powder. In some exemplary embodiments, the filtered fine pieces are pulverized while coarser pieces are not pulverized. For example, for EAF steel slag, the slag may be pulverized to a Blaine fineness of at least 50 m2/kg, and preferably about 180 m2/kg. For example, for EBH steel slag (mix of EAF and BOF and ladle slag), the slag may be pulverized to a Blaine fineness of at least 100 m2/kg and preferably about 240 m2/kg. In other exemplary embodiments, the steel slag may be pulverized to a finer size. In another example, at least fifty percent of ground slag to be smaller than 100 microns, D(50)<100 microns.

### Aggregates

The aggregates can be normal weight and lightweight of natural origin or man-made materials. They can be divided into coarse and fine aggregates according to their sizes. The type, proportion, and size of coarse and fine aggregates vary with their availability, cost and gradation, and also with the required workability of concrete mix, as well as the desired surface texture and properties of carbonated precast concrete. In some embodiments, fine aggregates have less than 5% particles with a diameter greater than ⅜″. In some embodiments, coarse aggregates have a diameter greater than ¼″. In a further embodiment, coarse aggregates have a diameter greater than ½″. In some embodiments, the term “normal weight” as used herein refers to naturally-occurring or crushed gravels or sand, from limestone, granite, etc., with a specific gravity about 2.7. In some embodiments, the term “lightweight aggregates” as used herein refers to natural or artificial particles with a specific gravity in the range of about 0.3 to about 1.9.

In one embodiment, the weight ratio of the aggregate to the total weight of the composition comprising the aggregate+binder+water+additives, ranges from about 0.3 to about 0.8, preferably from about 0.4 to about 0.7 or more preferably from about 0.40 to about 0.65.

### Additives

Additives for use herein include, but are not limited to, air entraining admixture, water reducing admixture, shrinkage reducing admixture, corrosion inhibiting admixture, accelerating or retarding admixture, viscosity modifier, pigment, water repellent admixture and other natural or chemical additives. Further ingredients/additives include fibers (such as Euclid's PSI Multi-Mix 80) that may be added in formulating carbonated precast concrete according to its final application. Additives can also be mineral admixtures.

Water reducing admixture is added to the concrete mixture in order to increase the compressive strength, reduce water content, decrease the porosity, and reduce the water permeability. The water reducing admixture is classified as plasticizer or superplasticizer (that is a polycarboxylate-based water reducer). Any water reducing admixture that is capable of reducing the required water content by up to about 50% or increasing the compressive strength by up to about 60% can be used as water reducer in the current innovation. The admixtures used in this innovation should meet the requirements of ASTM C494 (Standard Specification for Chemical Admixtures for Concrete, ASTM International, West Conshohocken, Pa., 2019).

Water repellent admixtures are designed to provide integral water repellency to concrete by affecting the capillary action of water into or out of the concrete. Water repellent admixtures can perform as static pore pluggers, creating a more difficult pathway for water migration, or can perform as reactive chemicals, forming “in situ” hydrophobic materials that not only plug pores, but also chemically repel water from concrete surfaces.

In certain embodiments of the present disclosure, an additive in accordance with the description herein is present in a conditioned demolded product (i.e. a conditioned article), or a portion thereof, intended to undergo the step of surface moisturizing as described herein and said additive is an air entraining admixture.

In one embodiment, the weight ratio of the air entraining admixture, as additive, to the total weight of the composition comprising the aggregate+binder+water+additives, ranges from about 0.0001 to about 0.001, or from about 0.0002 to about 0.0008 or from about 0.0004 to about 0.0006.

In certain embodiments, water repellent admixture is only present in a conditioned demolded product (i.e. the conditioned article), or a portion thereof, such as in a multilayered product, not intended/requiring to undergo the step of surface moisturizing as described herein.

In certain embodiments, water repellent admixture is present in the composition comprising binder(s), aggregates and water in a weight ratio (relative to the total weight of the composition) of at least about 0.005, or at least about 0.006, preferably at least about 0.007, or at least about 0.008, or at least about 0.009 or at least about 0.010.

In certain embodiments, water repellent admixture is present in the composition comprising binder(s), aggregates and water in a weight ratio (relative to the total weight of the composition) of at least about 0.005 and up to about 0.009-0.010.

### Water to Binder Ratio

Water-to-binder ratio depends on the manufacturing process (wetcast method or drycast method), the contents of binder and aggregates, and use and dosage of water reducer in a mix design. Generally, the water-to-binder ratio varies from about 0.10 to about 0.50 (weight basis ratio).

In one embodiment, the water-to-binder ratio ranges from about 0.10 to about 0.25.

In one embodiment, the water-to-binder ratio may be at least about 0.10, or at least about 0.11, or at least about 0.12, or at least about 0.13, or at least about 0.14, or at least about 0.15, or at least about 0.20 or at least about 0.25.

In one embodiment, the weight ratio of the water to the total weight of the composition comprising the aggregate+binder+water+additives, ranges from about 0.01 to about 0.10, preferably from about 0.05 to about 0.10 or more preferably from about 0.06 to about 0.08.

### EXAMPLES

### Materials and Sample Preparation

The cement used to cast concrete herein was Type GU ordinary Portland cement (Canadian Standard Association, CAN/CSA-A3001). For aggregates, crushed granite sand and stone were applied as coarse aggregate and fine aggregate, respectively, to minimize the effect of carbon content in aggregate on thermal analysis of samples. The maximum size of coarse aggregate was 12 mm and the fineness modulus of fine sand was 3.0. Superplasticizer provided by W. R. Grace (AVDA Cast 580) was added to attain a slump of 170 mm of concrete. Table 1 shows the mix proportion with a water-cement ratio of 0.4 and Table 2 presents the curing schemes. Batch 1 (B1) was hydration reference. Batch 2, 3 and 4 (B2, B3 and B4) were concretes carbonated in an expandable enclosure (FE) with a carbonation pressure of about 0.014 bar (0.2 psi) above a pressure of an environment E (FIG. 1) outside the enclosure 12. The carbonation duration was kept constant at 12 hours. B2 used same injection pressure and carbonation pressure at 0.014 bar (0.2 Psi) while B3 and B4 adopted a higher injection pressure of 0.41 bar (6 Psi). It took 9 minutes for B3 and 11 minutes for B4 to reach full inflation. Besides, the difference between B3 and B4 was that B4 was vacuumed by a pressure of 0.33 bar for 2 minutes to get rid of some air originally inside the FE. Batch 5 was cured in pressure chamber (PC) at high carbonation pressure (5 bars) serving as reference. Concrete cubes of 100×100×100 mm were used as specimens for all tests. 27 specimens were cast and carbonated for each batch of B2 to B5. The pressure (e.g., 0.2 PSI) may be a pressure differential between a pressure inside the expandable enclosure and a pressure of an environment outside the expandable enclosure.

TABLE 1
Mixture proportions of concrete

| | | Coarse | Fine | | | | | |
|---|---|---|---|---|---|---|---|---|
| Cement | Water | granite, | granite, | Concrete, | Superplasticizer | | | Slump, |
| (c), kg/m³ | (w), kg/m³ | kg/m³ | kg/m³ | kg/m³ | (sp), mL/m³ | w/c | sp/c, % | mm |
| 452 | 181 | 1060 | 680 | 2,375 | 2,055 | 0.4 | 0.5 | 170 |

TABLE 2
Curing schemes

| | | | | CO₂ Injection | | CO₂ Residence | |
|---|---|---|---|---|---|---|---|
| | | | | Injection | | Residence | |
| | Curing | | | Pressure | | Pressure | |
| Batch | Regime | Vessels | Vacuum | (Gauge) | Duration | (Gauge) | Duration |
| B1 | Normal | — | — | — | — | — | — |
| | Hydration | | | | | | |
| B2 | Carbonation- | Expandable | — | 0.014 bar | 45 mins | 0.014 bar | 11 hours and |
| | cured | enclosure | | (0.2 Psi) | | (0.2 Psi) | 15 mins |
| | | (FE) | | | | | |
| B3 | Carbonation- | Expandable | — | 0.41 bar | 9 mins | 0.014 bar | 11 hours and |
| | cured | enclosure | | (6 Psi) | | (0.2 Psi) | 51 mins |
| | | (FE) | | | | | |
| B4 | Carbonation- | Expandable | −0.33 bar | 0.41 bar | 10.5 mins | 0.014 bar | 11 hours and |
| | cured | enclosure | for 2 mins | (6 Psi) | | (0.2 Psi) | 49.5 mins |
| | | (FE) | | | | | |
| B5 | Carbonation- | Pressure | — | 5 bars | — | 5 bars | 12 hours |
| | cured | chamber | | | | | |
| | | (PC) | | | | | |

### Concrete Carbonation Curing Procedure

Carbonation curing procedure includes four steps: (1) In-mold curing, (2) Off-mold preconditioning, (3) Carbonation curing and (4) Subsequent hydration.

Carbonation-cured concrete specimens (CC) were cast in steel mold at ambient condition in a room of 23° C. and 50% relative humidity. The specimens were kept in mold for 5 hours until they reached initial set. Then, the specimens were demolded for precondition drying by using a fan at a wind speed of 1 m/s in ambient condition (25° C. and 50% RH). The temperature may be from 15 to 30 degree Celsius and the relative humidity may be from 30% to 60%. The wind speed may be from 0.5 to 1.5 m/s. This procedure was mainly designed to remove 40% of free water of each specimen based on its mix design in order to create porous channel for carbon dioxide penetration and make rooms for carbonates precipitation. In some embodiments, it may take about 5 to 6 hours for this preconditioning. After precondition drying, the specimens were placed in a closed carbonation vessel, either pressure chamber (PC) or expandable enclosure (FE), where the specimens were carbonated with various pressures up to 12 hours by applying pure CO2 gas of 99.9% purity at temperature of 25° C. and RH of 50%. Meanwhile, normal hydration concrete specimens (NC) were cast in the same molds for references and further cured in the moisture room (25° C. and 99% relative humidity) for 27 days as hydration control specimens after initial 24 hours curing in mold.

The schematic of carbonation curing setup is given in FIG. 1A and described herein above. In this curing system, the pressure reducer 16 was used to adjust the injection pressure of carbon dioxide while the regulator 17 was responsible for maintaining constant pressure for carbonation. A digital balance 18 connecting with a data acquisition system 19 was used for measuring mass curve of the carbonation system 10. The expandable enclosure (FE) 12 may have a dimension of 700×700×700 mm. Other dimensions are contemplated without departing from the scope of the present disclosure. However, when the FE 12 was fully inflated, its volume was close to 0.343 m3. This FE 12 had a pressure-resistant, air-tight zipper at its top and possessed a capacity of accommodating different sizes of concrete products and maintaining low carbonation pressure without gas leakage. Nevertheless, in the embodiment shown, a maximum pressure the FE 12 may be subjected to is about 0.056 bar (0.8 psi) above the pressure of the environment E according to the manufacturer suggestion. Other materials may have a higher pressure threshold. The carbonation pressure may be limited to 0.014 bar (0.2 psi), which was considered as ambient pressure as compared to high pressure carbonation at 1-5 bars. Besides, both FE 12 and rigid enclosure had inlet of gas injection and outlet of gas release. CO2 concentration was measured by a carbon dioxide analyzer (Model 906, Quantek Instruments), which was connected to the outlet to monitor the CO2 concentration during carbonation.

### CO2 Uptake

The CO₂ uptake of concrete through carbonation curing was estimated by three methods: mass gain method, thermal analysis method and mass curve method.

In mass gain method, the mass of specimen before carbonation was first measured by the digital balance 18, marked as m₁. And then after carbonation the specimen mass was measured again, represented as m₂. Because the carbonation curing was considered as exothermic, part of the free water would evaporate. This was the carbonation-induced water loss, named m_{water}, which was collected by absorbent paper and added to m₂. Therefore, the expression for CO₂ uptake related to the dry cement mass (m_{c}) according to the mix design is given as follows:

$${CO}_{2} Uptake ( \% ) = \frac{{m}_{2} + {m}_{w a t e r} - {m}_{1}}{{m}_{c}} \times 100 \%$$

In thermal analysis method, 10 g concrete powders at depth of 0-10 mm, 10-25 mm and 25-50 mm were collected by different diameter drill bits and decomposed at 105, 550 and 1000° C. to determine their mass loss at each temperature as m₃, m₄ and m₅. To prevent cross contamination between layers, the diameters of drill bits for collecting concrete powders were varied from outer layer to inner layer of concrete, with 16 mm-diameter for 0-10 mm layer, 13 mm-diameter for 10-25 mm layer, and 10 mm for 25-50 mm layer, respectively. Furthermore, compressed air was applied to clean the hole of every layer after drilling and the drill bit. At least 8 holes were drilled for each layer of each batch within the core region of 100 mm cube to minimize the edge effect. The decomposition of calcium carbonate between 550 and 1000° C. was assumed to be related to the mass loss of carbon dioxide. The equation below provides the calculation equation for thermal analysis method. Besides, the mass loss of sample between 105° C. and 550° C. was mainly attributes to the loss of non-evaporable water content from decomposition of hydration products including CH, Aft and CSH. This could be considered as an indication of hydration extent. The equation below shows its calculation. 0.24 is the theoretical required water content for full hydration of cement.

$${CO}_{2} Uptake ( \% ) = \frac{{m}_{4} - {m}_{5}}{cement mass based on {m}_{3}} \times 100 \% \\ Hydration exent ( \% ) = \frac{{m}_{3} - {m}_{4}}{cement mass based on {m}_{3} * 0.24} \times 100 \%$$

In mass curve method, the digital balance 18 connecting with computer 19 was applied for measuring the mass increase of specimens due to the carbon uptake by cement from the beginning to the end of carbonation curing. The balance 18 (Model of EP32001C Basic AM of OHAUS Corporation) had a capacity of maximum 32 Kg and precision of 0.1 g. Once the concrete samples were placed inside the vessels (FE and PC), the vessels were sealed, and the balance 18 was tared to zero. Then the gas was injected into the vessels and the mass increase due to the carbon uptake by concrete was recorded. At the end of carbonation, the CO₂ gas was released, and the residual mass of the system was recorded as M_{gain}. The residual mass was the sum of CO₂ uptake by concrete and CO₂ residual in the vessel. To determine the CO₂ residual in the vessel, the same procedure was repeated using CO₂-insensitive Styrofoam™ samples with same volume as concrete samples. The residual mass of this calibration system was denoted as M_{cal}, representing CO₂ residual in the vessel. The difference between M_{gain} and M_{cal} was CO₂ uptake. The percent CO₂ uptake by concrete in terms of cement mass by mass curve method is given in the equation below.

$${CO}_{2} Uptake ( \% ) = \frac{{M}_{g a i n} - {M}_{cal}}{Mass of cement} \times 100 \%$$

The CO₂ uptake of the 100 mm concrete cubes was determined using mass curve and mass gain methods (Table 3), whereas the distribution of CO₂ content along the sample depth was determined through thermal analysis of the drilled powders (Table 4).

TABLE 3
Effect of CO2 gas injection pressure and vacuum on CO2
concentration of vessels and CO2 uptake of concrete

| | 30-min carbonation reaction | | 12-hour carbonation reaction | | |
|---|---|---|---|---|---|
| | CO₂ | CO₂ uptake | CO₂ | CO₂ uptake | CO₂ uptake |
| | concentration | of mass curve | concentration | of mass curve | of mass gain |
| Batch | (%) | (%) | (%) | (%) | (%) |
| B2 | 57.30 | 1.34 | 83.30 | 7.36 | 7.34 ± 0.13 |
| B3 | 84.40 | 1.85 | 84.80 | 8.64 | 8.45 ± 0.22 |
| B4(vacuum) | 95.10 | 2.45 | 95.60 | 11.2 | 11.1 ± 0.79 |
| B5 | 99.99 | 3.08 | 99.99 | 12.3 | 12.1 ± 0.66 |

TABLE 4
Carbon dioxide content distribution by drilled powder method
in concrete subject to 12 h carbonation curing (%)

| | | Depth | 12-hour carbonation | | | | | 27-day subsequent hydration | | | | |
|---|---|---|---|---|---|---|---|---|---|---|---|---|
| Region | Definition | (mm) | B1 | B2 | B3 | B4 | B5 | B1 | B2 | B3 | B4 | B5 |
| I | Carbonated | 0-10 | 5.30 | 17.03 | 18.91 | 21.75 | 23.24 | 6.88 | 18.17 | 20.32 | 22.69 | 24.52 |
| II | Lightly- | 10-25 | 3.97 | 8.21 | 8.68 | 11.87 | 12.52 | 3.58 | 8.43 | 8.54 | 12.13 | 12.83 |
| | carbonated | | | | | | | | | | | |
| III | Non-carbonated | 25-50 | 4.03 | 4.24 | 4.11 | 4.93 | 4.73 | 3.13 | 4.36 | 3.79 | 4.93 | 4.64 |

Table 3 shows the effect of CO₂ gas injection pressure (compared B2 and B3) and vacuum (compared B3 and B4) on CO₂ concentration in the enclosure of vessels as well as CO₂ uptake of concrete. Prior to CO₂ injection, the enclosure was filled with air in B2 and B3. Apparently, the higher injection pressure of B3 could increase the CO₂ concentration faster, measuring 84.4% at 30-min carbonation with carbon uptake of 1.85% based on cement mass, compared to the CO₂ concentration of 57.3% and CO₂ uptake of 1.34% in B2. Furthermore, the relatively higher injection pressure (IP) adopted by B3 led to a rapid CO₂ injection process and therefore allowed a longer carbonation resident time at the final pressure (11 hours and 51 mins as opposed to 11 hours and 15 mins for B2). Consequently, B2 and B3 achieved different but comparable CO₂ uptake after 12-hour carbonation which were respectively 7.36% and 8.64% upon the mass curve method. By introducing a vacuum process prior to CO₂ injection, B4 had elevated the CO₂ concentration of FE up to 95.1% in 30 minutes, presenting a higher CO₂ uptake of 2.45% after 30-min carbonation curing. Due to high concentration, the mass curve of B4 demonstrated a fast reaction rate in the first 3 hours, generating more than 60% of the total CO2 uptake. Then the carbonation reaction rate was reduced due to the increasing precipitation of reaction products before reaching an accumulated value of about 11.2% at 12 hours. This was indicative that early-age carbonation reaction subjected to ambient pressure was also a diffusion-based reaction observed in high pressure carbonation (B5). The impact of high pressure on CO₂ uptake in B5 was the most prominent one among all the batches. High pressure (B5) ensured higher concentration and showed the highest carbonation reaction rate at the beginning, achieving 3.08% CO₂ uptake at 30-min and further promoting it to 12.3% for 12 hours. However, the gain of CO₂ uptake from B4 to B5 appeared to be of close (i.e., from 11.2% to 12.3%) compared to the pressure increase from 0.014 bar to 5 bars. The high pressure was likely effective in accelerating carbonation at the beginning but may slow down the later reactions due to the fast carbonate precipitation in the pore network. This was also evidenced by the results of mass curves. During the first 6 hours of CO₂ exposure, B5 attained 94.9% of its 12-hour CO₂ uptake, whereas B2, B3 and B4 achieved only 85.3%, 84.5% and 82.3%, respectively. It was indicative that the concretes carbonated at ambient pressure possessed a relatively higher rate of CO₂ uptake after 6 hours compared to high pressure. This was probably due to a less dense surface layer generated by the ambient-pressure carbonation that allowed a consistent diffusion of CO₂ throughout the carbonation process.

Apart from mass curve, the mass gain method was applied to verify the CO₂ uptake as shown in Table 3. Specimens of B2 to B4 were cured in FE at ambient pressure while B5 were treated by high carbonation pressure in PC. Uptakes of all batches by the mass gain method were slightly lower than those measured by mass curve method, recording 7.34% in B2, 8.45% in B3, 11.1% in B4 and 12.1% in B5. The lower CO₂ uptake measured by mass gain method was attributed to the evaporated water from specimens during carbonation which could not be fully collected. The highest uptake of concrete by mass gain method in FE at 0.014 bar was 11.1%, slightly less than that in PC at 5 bars.

Referring to FIGS. 3A to 4B, in order to quantify the carbon content at different depth produced by carbonation curing in both ambient pressure and high pressure as well as to compare CO₂ uptake results with both mass curve method and mass gain method, thermal analysis was conducted in all batches. The calculation of carbon dioxide content distributions in concrete is presented in Table 4 according to the equation above. Normal hydration concrete B1 was executed as reference. Marked as Region I, the first layer was considered as carbonated layer, where carbon content was highest compared to other two inner layers, Region II and Region DI, in every batch after 12-hour carbonation curing or after 27-day subsequent hydration. This implicated the surface of concrete was modified by carbonates, likely contributing to strength gain or other properties of concrete. After 12-hour carbonation curing, B5 cured in PC with carbonation pressure of 5 bars was recorded with highest uptake, 23.24% in Region I, followed by 12.52% in Region II and 4.73% in Region DI. B4 treated by vacuum and cured with carbonation pressure 0.014 bar in FE was measured the second highest uptake 21.75% in Region I, 11.87% in Region II and 4.93% in Region DI. It was suggestive that carbonated concrete subject to ambient carbonation pressure in FE still could have similar carbon dioxide distribution as high pressure in PC. In Region II, B2, B3, B4, and B5 were still seen to have carbon content with reading of 8.21%, 8.68%, 11.87% and 12.52%, respectively, so Region II was treated as lightly carbonated, which meant this layer was possibly affected by CO₂ penetration during carbonation curing. There was no distinct carbon uptake in Region DI in all carbonation curing batches when comparing to normal hydration references in B1. This indicated that carbonation curing could be applied to reinforced concrete structures because the 25 mm distance from concrete surface could be the location of reinforcing steel. After 27-day subsequent hydration, the carbon content readings in all carbonation curing batches shared the similar tendencies with those after 12-hour carbonation. It was noted that the measurements in Region I after 27 days in all batches were higher than those after 24 hours. This was possibly because the atmospheric CO₂ was reacting with outer layer of concrete and creating more carbonate products.

In order to compare the CO₂ uptake among three methods, mass gain, mass curve, and thermal analysis, the CO₂ uptakes of thermal analysis of all batches based on layer volume are calculated and summarized at Table 5. It was observed that CO₂ uptakes in thermal analysis method were consistent with the former two methods (mass gain and mass curve in Table 3), 7.47% versus 7.34% and 7.36% in B2, 8.52% versus 8.45% and 8.64% in B3, 11.2% versus 11.1% and 11.2% in B4, and 12.3% versus 12.1% and 12.3% in B5, respectively. It seemed that these three methods to quantify the CO₂ uptake in concrete had an agreement that early age carbonation curing in ambient pressure as well as in high pressure could convert the CO₂ into carbonate, permanently stored in concrete for emission reduction.

TABLE 5
CO2 uptake of concrete by thermal analysis method (%)

| Batch | 12-hour carbonation | 27-day subsequent hydration | Average |
|---|---|---|---|
| B2 | 7.39 | 7.54 | 7.47 |
| B3 | 8.47 | 8.56 | 8.52 |
| B4 | 11.20 | 11.25 | 11.2 |
| B5 | 12.15 | 12.38 | 12.3 |

### Compressive Strength Test

Compressive strength was a direct way to investigate the contribution of carbonation curing under either ambient pressure or high pressure on strength gain of concrete. Three specimens of each group were tested on 1 day and 28 days since casting according to ASTM C140-20a (as published on Jun. 1, 2020) and averaged.

The compressive strength of concretes carbonation-cured in both ambient pressure and high pressure is shown in FIG. 5. B2, B3 and B4 concretes were carbonation-cured in FE 12 (FIG. 1) with ambient pressure as 0.014 bar for about 12 hours while B5 was subjected to high pressure as 5 bars in PC for the same carbonation duration. All concrete batches were tested on 1-day and 28-day. Right after 12-hour carbonation curing, the compressive strength was significantly improved by carbonation curing in both ambient pressure and high pressure. Compared to the reference strength in normal hydration concrete (B1), the increase was 32.2% in B2 (29.4 MPa), 51.3% in B3 (33.7 MPa), 72.9% in B4 (38.7 MPa), and highest 78.2% in B5 (39.7 MPa). It seemed that early-age carbonation curing in both FE (ambient pressure, 0.014 bar) and PC (high pressure, 5 bars) could contribute to the strength gain. And vacuum effect of B4 could further improve the strength than B3 by increasing the concentration to 99.9% to enhance the carbon uptake.

After 27-day subsequent hydration, the carbonated concretes cured in FE still had higher compressive strength than the hydration reference. However, the growth between them was not as significant as 24-hour strength, only 3.26% in B2, 4.15% in B3, 5.47% in B4 and 10.3% in B5. In some embodiments, early age carbonation curing could make high strength concretes in the early stage of hydration without hindering later strength gain after 27-day subsequent hydration. Carbonated concretes treated with ambient pressure in FE 12 could have similar compressive strength as those subjected to high pressure in PC. FIG. 6 displays a logarithmic fitting relationship between the CO₂ uptake and compressive strength. Normally, higher uptake had higher strength, but the rate of strength gain was reduced.

### Evaluation of pH Values and Carbonation Curing Depth

PH values at different depths across the cross-section of the specimen were tested by a pH meter (Extech PH110) with a plane head diameter of 6 mm. The specimen was first separated into two parts from the center of specimen by applying splitting tension under a small compressive machine with the help of iron rod placing in the middle of top surface. Then the pH values were measured at 5 mm, 17.5 mm and 37.5 mm from the edge of the freshly broken surface. The testing point chosen was covered with a scrap of absorbent paper before pouring it with small amount of deionized water until the diffusion equilibrium was achieved for normally 1 min. Normal hydration concrete at different age presented a reference pH of 12.3 to 12.8 by using this method. Besides, a metal Vernier caliper with digital reading was applied to measure the carbonation curing depth after spraying phenolphthalein solution across the cross-section of the specimen. At least 3 measurements were taken on each side before averaging them.

CO₂ can react with calcium hydroxide to generate calcium carbonate, thus reducing the pH of concrete. Therefore, during the early age carbonation curing under either ambient pressure or high pressure, it may be necessary to know their influence on alkalinity of concrete. It was determined by the pH value of concrete after 12 h carbonation and after 27-day subsequent hydration. PH values at different layers of all batches cured in both ambient pressure and high pressure were examined and summarized in Table 6. After 12-hour carbonation, in the first layer (Region I), carbonated concrete specimens B5 treated by high pressure as 5 bars for 12-hour in PC exhibited the most reduction in pH, about 9.39, following by 10.69 in B4, 11.15 in B3, and 11.43 in B2. This was in accordance with the high carbon content detected by three carbon uptake estimation methods in Region I where carbon dioxide reacted with calcium hydroxide to reduce the alkalinity to some extent. Even though B4 (11.1%) had a close carbon uptake as B5 (12.1%), its pH reduction was not as significant as B5. It seemed that carbonated concretes subject to ambient pressure possessed higher alkaline value than high pressure. In the Region II, B4 and B5 seemed to be less affected, recording a pH value as 11.86 for B4 and 11.32 for B5, which suggested that carbon dioxide possibly affected Region II to a lesser degree in both ambient pressure and high-pressure carbonation curing. However, the effect of carbonation curing on pH values of B2 and B3 was minimal, mainly attributing to the fact that CO₂ gas was hard to further penetrate inside the concrete under such ambient pressure within 12 hours. Moreover, pH values in Region DI for all batches were hardly affected during the carbonation curing of concrete, all measuring above 12.5, which were comparable to those pH values in normal hydration reference concrete. This confirmed with thermal analysis results again that carbonation curing did not affect the area that was 25 mm from surface. Ambient pressure carbonation might stand a better chance than high pressure to protect reinforcing steel bar from corrosion due to pH reduction.

TABLE 6
pH distribution in carbonatino-cured concretes

| | After 12-hour carbonation | | | | After 27-day subsequent hydration | | | |
|---|---|---|---|---|---|---|---|---|
| Region | B2 | B3 | B4 | B5 | B2 | B3 | B4 | B5 |
| I | 11.43 ± | 11.15 ± | 10.69 ± | 9.39 ± | 12.05 ± | 12.09 ± | 12.06 ± | 12.03 ± |
| | 0.39 | 0.31 | 0.72 | 0.52 | 0.11 | 0.12 | 0.22 | 0.05 |
| II | 12.63 ± | 12.62 ± | 11.86 ± | 11.32 ± | 12.6 ± | 12.65 ± | 12.73 ± | 12.51 ± |
| | 0.22 | 0.21 | 0.25 | 0.19 | 0.09 | 0.03 | 0.08 | 0.21 |
| III | 12.62 ± | 12.63 ± | 12.63 ± | 12.6 ± | 12.77 ± | 12.63 ± | 12.65 ± | 12.53 ± |
| | 0.06 | 0.05 | 0.05 | 0.2 | 0.05 | 0.08 | 0.03 | 0.15 |

After 27-day subsequent hydration, the pH values of all layers of all batches were measured above 12, especially for the reading of Region I in B4 and B5, recovering from average 10.69 to 12.06 for B4 and from about 9.39 to 12.03 for B5. This meant subsequent hydration was beneficial and vital for pH recovery after early age carbonation curing. This phenomenon was better illustrated by spraying phenolphthalein after 12-hour carbonation and 27-day subsequent hydration, displayed in FIGS. 3A, 3B, 4A, 4B. Three regions were defined by dimensions, Region I (0-10 mm), Region II (10-25 mm) and Region DI (25-50 mm). Immediately after 12-hour carbonation, carbonation depths were detected by colorless front only in Region I and recorded as 3.9 mm for B4, and 7.61 mm for B5. Even though B4 and B5 had a close value of CO₂ uptake as 11.1% and 12.1% based on mass gain method, their carbonation depths were still within 10 mm from the surface. However, after 27-day subsequent hydration, all colorless fronts in all batches had disappeared, suggesting that after early age carbonation curing, concrete still had the capacity to gain normal alkalinity in concretes.

### Surface Electrical Resistivity and Absorption

Surface electrical resistivity performance was tested on surfaces of concrete at 23° C. on 1-day and 28-day following AASHTO TP95 protocols. After immersing the concrete in water for 72 hours at 23° C., the surface moisture was removed by a towel and resistivity was measured on four side surfaces by using Proceq Resipod Resistivity Meter with a four-point probe, of which electric current was generated between outer two probes and detected by inner ones for calculation of resistivity. Four measurements were recorded and averaged.

Absorption of both normal hydrated and carbonated concretes was conducted at 1-day and 28-day stage according to ASTM C642-13. Specimen was first dried in an oven at a temperature of 105° C. for 72 hours. After being cooled down to room temperature at 23° C., the oven-dry mass was recorded as mₐ. Then the specimen was fully immersed in water for 48 hours at 21° C. before boiling for 5 hours and cooling it down for 16 hours. After removing the surface moisture with a towel, its saturated mass at room temperature of 23° C. was measured as m_{b}. Finally, the specimen was suspended in water to determine the immersed apparent mass as m_{c}. The permeable porosity of carbonation-cured and normal hydration concretes was calculated by the equation below.

$$Porosity = \frac{{m}_{b} - {m}_{a}}{{m}_{b} - {m}_{c}} \times 100 \%$$

Based on the thermal analysis result, Region I had the highest carbon content after carbonation curing. Thus, it was necessary to examine whether this increase in carbonates could have some effects on porosity and permeability of concrete. FIG. 7 compares the electrical resistivity test results between carbonated concrete specimens (B2 to B5) and reference concrete (B1). It was noticed that early carbonation curing in ambient pressure had yielded the resistivity in concrete comparable to in high pressure. The resistivity measured at 1-day was 47.5 kΩ·cm for B2, 53.2 kΩ·cm for B3, 66.6 kΩ·cm for B4 of ambient pressure carbonated concretes and 67.2 kΩ·cm for high pressure carbonated concrete (B5). B4 and B5 were 7 times higher than that for normal hydration concrete, only 9.4 kΩ·cm. After 27-day subsequent hydration, the carbonated concrete still kept the advantage, recording 2.9 times in B2 (63.9 kΩ·cm), 3.3 times in B3 (71.6 kΩ·cm), 3.6 times in B4 (79 kΩ·cm), and 4.6 times in B5 (102.1 kΩ·cm) compared to reference concrete, 22 kΩ·cm. Generally, higher resistivity of concrete always indicates low porosity. Therefore, the surfaces of concretes after early age carbonation curing in both ambient pressure and high pressure were most likely densified by carbonates, and the effect of carbonation on densifying the surface by ambient pressure was comparable to that by high pressure at one day. FIG. 8 exhibits a logarithmic correlation between carbonation degree and compressive surface electrical resistivity. Similar to that of compressive strength, higher carbonation degree boosted the resistivity, but its effect was decelerated as carbon uptake continued to increase.

The permeable porosity reading of reference concrete (B1) and carbonated concrete (B2 to B5) is exhibited in FIG. 9. In 1-day testing, the porosity was reduced from 13.5% of B1 in reference concrete to 13.1% of B2, 12.9% of B3 and 12.6% of B4 in ambient pressure carbonated concretes and 11.6% of B5 in high pressure carbonated concrete. The highest reduction percentage was about 7.24% in ambient carbonation pressure and approximate 14.2% in high pressure carbonation. After 27-day subsequent moist curing, all concrete batches had a decreasing porosity, 11.3% for B1, 10.8% for B2, 10.6% for B3, 10.1% for B4 and 9.9% for B5. Even though ambient pressure did not have the same effect as high pressure in term of reducing porosity, ambient pressure may be effective to improve concrete performance when applying early-age carbonation curing. It was also indicative that early age carbonation curing may not impede further hydration so that the concrete could have lower porosity at later hydration stage. FIG. 10 shows that higher carbon uptake can reduce the porosity to some extent although a weaker logarithmic correlation is found between the carbonation degree and porosity.

### Ultrasonic Pulse Velocity Test

Ultrasonic pulse velocity (UPV) is a non-destructive test to assess the uniformity and relative quality of concrete, indicating the presence of voids and cracks. Higher velocity always means less voids and cracks inside the concrete. UPV test was carried out on both carbonated and hydrated concretes in saturated surface dry condition at 1 day and 28 days following the ASTM C597 standard. The UPV testing device was TICO made by PROCEQ Testing Instruments with two transducers, one for transmitting the signal while the other for receiving it. After calibrating the time for the calibration steel rod (20.5 μs), the two coupling transducers were placed in the middle of concrete surface of 100 mm cube and the travelling time was recorded until three consecutive readings with small deviation (±0.1 μs) were attained. In the meantime, the travelling lengths of concrete samples were also measured by a digital Vernier caliper. Therefore, the ultrasonic pulse velocity can be calculated by the equation below.

$$Velocity = \frac{L}{T}$$

Where L is the distance between two transducers along the concrete specimen while T is the ultrasonic wave travelling time in the concrete specimen measured by TICO device.

FIG. 11 presents the ultrasonic pulse velocity (UPV) for carbonated concrete cured in ambient pressure (B2 to B4) and high pressure (B5) as well as reference concrete (B1) both on 1 day and 28 days. It was notable that the velocities of B2, B3, B4 and B5 on 1 day were higher than that in B1, reading 4539 m/s, 4586.6 m/s, 4691.2 m/s and 4784.7 m/s, respectively, compared to 4447.7 m/s in reference. The corresponding increases were 2.05%, 3.12%, 5.47% and 7.58%, which indicated that the carbonated concrete had relative better quality and less voids than reference concrete. Carbonates were deposited inside and densified the carbonated-cured concrete, which agreed with surface resistivity and porosity results. The velocities of all concrete specimens were increased after 27-day subsequent hydration, 4573.2 m/s for reference concrete, 4664.3 m/s for B2, 4707.4 m/s for B3, and 4800 m/s for B4 of ambient pressure carbonated concrete and 4886 m/s for B5 of high pressure carbonated concrete. This was considered as another evidence that early age carbonation curing did not hinder the subsequent hydration since the carbonated concrete became denser at the later hydration stage. A good logarithmic correlation between carbonation degree and ultrasonic pulse velocity is displayed in FIG. 12. Increasing the carbon uptake could elevate the velocity of ultrasonic pulse travelling through the carbonated concrete since the deposition of calcium carbonates contributed to the densification of concrete.

Table 7 presents the hydration extent of Region I of B1 to B5 after 27-day subsequent hydration. It seemed that carbonation curing did not hinder subsequent hydration, instead it accelerated the cement hydration. This is mainly attributed to the carbonation reactions of cement components (3CaO.SiO₂ and 2CaO.SiO₂), generating CSH to develop early strength. Besides, calcium carbonates will be formed and filled in the pore space of the mixture during carbonation curing and further densify the structure during subsequent hydration, contributing to the improved performances, including strength, electrical resistivity and so on.

TABLE 7
Non-evaporable water content of Region I of concrete
after 27-day subsequent hydration (%)

| Batch | B1 | B2 | B3 | B4 | B5 |
|---|---|---|---|---|---|
| Water | 59.7 | 58.1 | 67.1 | 69.0 | 73.7 |
| content | | | | | |

### Scanning Electron Microscopy (SEM) Analysis

To study the microstructures of both normal hydration reference and carbonation-cured concretes, small pieces of fracture surface of samples in the near surface region (0-10 mm) after 27-day subsequent hydration were examined by using scanning electron microscopy (SEM) Hitachi SU3500 for morphology and Energy-dispersive X-ray spectroscopy (EDS) for element analysis.

FIGS. 13A to 15C demonstrate the SEM micrographs and EDS analysis of concretes subjected to ambient pressure carbonation (FIGS. 13A to 13D, B4), conventional hydration (FIGS. 14A-14B, B1) and high-pressure carbonation (FIGS. 15A to 15C, B5) in Region I at 28 days. Compared FIG. 13A with FIG. 14A, it seemed that concrete carbonation-cured in ambient pressure had a denser structure and finer texture than normal hydration concrete. Calcium carbonate smaller than 1 μm was found under ambient pressure carbonation (as low as 0.014 bar) after 27-day subsequent hydration, seen in FIGS. 13A and 13B. High carbon content with strong peak of Ca, Si, and O was detected in Site #2, showing in FIGS. 13A and 13C. It appeared that very small sizes of calcium carbonates were embedded in the CSH. This indicated that carbonates generated by carbonation curing under ambient pressure were always intermingled with C—S—H gel, making contributions to higher surface resistivity, lower porosity and faster velocity of carbonated concrete. The deposition of carbonates seemed to modify the microstructure of concrete and contribute to its durability. After 27-day subsequent hydration, amorphous structure C—S—H with strong peaks of Ca, Si, and O were found in both ambient pressure carbonated and hydrated concrete, shown in Site #3 (FIG. 13D) and Site #4 (FIG. 14B) in the surface of concrete. This was evident that carbonation curing in ambient pressure for concrete did not hinder the subsequent hydration even for the heavily carbonated region. However, for high pressure carbonated concrete (B5, Site #5 in FIGS. 15A to 15C), crystal form of grain-like shape of calcium carbonate about 1 μm was distinguished in Region I at 28 days. This could be the evidence that carbonation under ambient pressure could generate different carbonates from high pressure. High pressure was more inclined to produce larger sizes and different crystallization of carbonates. In comparison of EDS point analysis for Site #1 and Site #5, the higher relative intensity of silicon in high carbonation pressure (B5, 5 bar) was indicative that the degree of intermingling effect between calcium carbonate crystals and C—S—H was higher than ambient carbonation pressure (B4, 0.014 bar). Finally, typical amorphous C—S—H was also detected in the heavily carbonated region of concrete under high carbonation pressure, shown in Site #6 in FIG. 15D. In conclusion, the microstructure studies herein were implicative that carbonated concretes subject to both ambient pressure and high pressure would generate a hybrid of hydrates and carbonates, contributing to the performance development of concretes.

### Advantages of Ambient Pressure Carbonation in an Expandable Enclosure (FE)

Early-age carbonation curing is an alternative curing method that may improve performance of concrete and may reduce CO₂ emission by permanently sequestering gaseous CO₂ as solid carbonates into concretes. Compared to high pressure carbonation process, concrete subject to ambient pressure carbonation may still attain the same level of CO₂ uptake. From the technical point of view, ambient pressure may limit the carbonation depth within surface 10 mm, which may minimize the possibility of carbonation-induced corrosion and possibly opens more applications to reinforced concrete products. Furthermore, the expandable enclosure 12 (FE) may be capable of accommodating different shapes and sizes of concrete products, including concrete pipes, concrete blocks, hollow-core slabs, bridge decks, and railway ties. FE 12 is more likely a mobile carbonation curing vessel and can be potentially applied in shops or on job sites.

The use of ambient pressure system may be potentially advantageous with respect to the system cost compared to the traditional high-pressure rigid chamber. For the same volume of enclosure (0.34 m³), the price was cheaper for plastic expandable enclosure than for high-pressure steel chamber by a ratio of about 4. The cost saving may mostly result from the less expensive enclosure body and sealing parts as the gas pressure reduced from 5 to 0.014 bar. Potential costs associated with the CO₂ pressurization could also be minimized. When scaling up to industrial practice, additional investments may be anticipated for the high-pressure system due to the increased safety concerns that require systematic upgrading of precast equipment and protocol. By eliminating the need for high-pressure operations, the expandable enclosure would demonstrate significant cost efficiency at the industrial scale.

Besides the cost reduction, the ambient pressure system opens opportunities for a broad range of precast products at scale, as well as new applications in the sizable cast-in-place concrete market. For 22 million tonnes of concrete pipes annually produced in the United States of America, the ambient pressure carbonation in FE can utilize 463,980 tons of carbon dioxide according to 11% CO₂ uptake and 19% cement content used in pipes. The ambient carbonation of concrete pipes can be carried out piece by piece or in a group in a specially designed enclosure, similar to the current practice of steam curing of the pipes. For concrete masonry units (CMU), one 200 mm standard CMU with a mass of 15 kg contains 13% cement. Based on 11% CO₂ uptake, ambient pressure carbonation curing could consume 0.93 million tonnes of CO₂ by assuming that 4.3 billion units of concrete blocks are produced in US and Canada per year. The expandable enclosure may eliminate the need of steam chamber and can be designed to wrap the entire rack with layers of blocks. The carbonation can be carried out rack by rack anywhere indoor or outdoor. Carbonation curing at ambient pressure may make contribution to the reduction of CO₂ emission while improving the performance.

### CONCLUSIONS

For wet-cast concrete carbonation-cured in an expandable enclosure, the carbonation procedure with 2-min vacuum, 10-min high injection pressure at 0.41 bar and 12-hour carbonation at 0.014 bar may achieve a carbon dioxide uptake up to 11% based on cement mass, which was comparable to CO₂ uptake of 12% in concrete subject to high carbonation pressure of 5 bars in a stiff pressure chamber. This result was surprising and contrary to the literature that advocates for high pressure curing.

The uptakes revealed that ambient pressure curing may be as effective as high pressure in terms of precipitation of gaseous CO₂ into concrete. Furthermore, the thermal analysis results showed that carbonation curing reactions mainly took place on surface (0-10 mm) due to ambient pressure. Carbonates modified the microstructure of concrete surface, contributing to the strength gain and durability of concrete.

The reduction of alkalinity of concrete subjected to ambient pressure carbonation may be less than that cured in high pressure. Besides, the carbonation depth was also smaller by ambient pressure carbonation than by high pressure. Concrete treated in ambient carbonation pressure could have a better performance than that in high pressure regarding to the protection of the reinforcing steel bar inside the concrete from carbonation-induced corrosion. However, in some embodiments, subsequent hydration may be required to recover pH values to above 12 after early-age carbonation curing.

In terms of performances, the early-age carbonated concrete (B4) in ambient pressure still had higher compressive strength, greater surface resistivity, lower porosity and faster ultrasonic pulse velocity than normal hydration concrete, proving that ambient pressure carbonation was as effective as high pressure to make contribution to the strength gain and durability of concretes.

The ambient and high carbonation pressures potentially created different concrete microstructure with different levels of compactness. SEM results showed that crystal form of grain-like shape of calcium carbonates were detected in the concretes cured by both high-pressure carbonation and ambient-pressure carbonation after 27-day subsequent hydration. High pressure was more likely to produce larger size and better crystallization of carbonates. However, it was indicative that carbonates were intermingled with C—S—H, contributing to the performance improvement of concrete subject to ambient pressure carbonation curing.

In the context of the present disclosure, the expression “about” should be construed as encompassing values varying by plus or minus 10%. For instance, about 10 includes values from 9 to 11.

As can be seen therefore, the examples described above and illustrated herein are intended to be exemplary only. The scope is defined by the appended claims.

What is claimed is:

1. A method for making a carbonated precast concrete product, comprising:
obtaining a mixture including at least one binder material, an aggregate, and water;
molding the mixture into a molded intermediate;
demolding the molded intermediate to obtain a demolded intermediate, the demolded intermediate having a first water-to-binder ratio;
conditioning the demolded intermediate to provide a conditioned article having a second water-to-binder ratio less than the first water-to-binder ratio of the demolded intermediate; and
curing the conditioned article using carbon dioxide at a pressure ranging from an atmospheric pressure to a pressure greater than the atmospheric pressure by at most 10% of the atmospheric pressure.

2. The method of claim 1, wherein the curing of the conditioned article includes curing the conditioned article at the pressure greater than the atmospheric pressure by at most 5% of the atmospheric pressure.

3. The method of claim 2, wherein the curing of the conditioned article includes curing the conditioned article at the pressure greater than the atmospheric pressure by at most 0.2 psi.

4. The method of claim 1, wherein the molding of the mixture into the molded intermediate includes pre-curing the molded intermediate.

5. The method of claim 4, wherein the pre-curing of the molded intermediate includes pre-curing the molded intermediate for about five hours at a temperature of about 23 degrees Celsius and at a relative humidity of about 50% and exposed to an airflow having a speed of about 1 m/s.

6. The method of claim 1, wherein the conditioning of the demolded intermediate includes exposing the demolded intermediate to a wind having a speed of about 1 meter per second at a temperature of about 25 degrees Celsius and at a relative humidity of about 50%.

7. The method of claim 1, wherein the conditioning of the demolded intermediate includes conditioning the demolded intermediate until about 40% of a water content of the demolded intermediate has evaporated.

8. The method of claim 1, wherein the conditioning of the demolded intermediate includes conditioning the demolded intermediate until the conditioned article defines a porosity of about from 5 to 10% by volume.

9. The method of claim 1, wherein the curing of the conditioned article at the pressure greater than the atmospheric pressure by at most 10% of the atmospheric pressure includes disposing the conditioned article into an expandable enclosure defining an inner chamber sealed from an environment outside thereof.

10. The method of claim 9, comprising injecting the carbon dioxide into the expandable enclosure.

11. The method of claim 10, comprising vacuuming the expandable enclosure before the injecting of the carbon dioxide.

12. The method of claim 1, comprising hydrating the concrete product after the curing at a temperature of about 25 degrees Celsius and at a relative humidity of about 99%.

13. The method of claim 12, wherein the hydrating includes hydrating the concrete product for 27 days.

14. A method for making a carbonated precast concrete product, comprising:
obtaining a conditioned article, the conditioned article being a molded intermediate concrete product;
sealing the conditioned article within an inner chamber of an expandable enclosure, the expandable enclosure having an operational configuration and a non-operational configuration, a volume of the inner chamber greater in the operational configuration than in the non-operation configuration;
injecting carbon dioxide inside the inner chamber until a pressure inside the inner chamber ranges from an atmospheric pressure to a pressure greater than the atmospheric pressure by at most 10% of the atmospheric pressure; and
curing the conditioned article with the carbon dioxide injected inside the inner chamber of the expandable enclosure to produce the carbonated precast concrete product.

15. The method of claim 14, comprising deploying the expandable enclosure from the non-operational configuration to the operational configuration.

16. The method of claim 15, wherein the deploying of the expandable enclosure includes inflating the expandable enclosure with the injecting of the carbon dioxide inside the inner chamber.

17. The method of claim 14, wherein the curing of the conditioned article includes curing the conditioned article at the pressure greater than the atmospheric pressure by at most 5% of the atmospheric pressure.

18. The method of claim 17, wherein the curing of the conditioned article includes curing the conditioned article at the pressure greater than the atmospheric pressure by at most 0.2 psi.

19. The method of claim 14, comprising vacuuming the expandable enclosure before the injecting of the carbon dioxide while the conditioned article is inside the inner chamber.

20. The method of claim 14, wherein the curing of the conditioned article is performed at a temperature of about 25 degrees Celsius, for 12 hours, the method comprising hydrating the concrete product after the curing at a temperature of about 25 degrees Celsius and at a relative humidity of about 99%.
